(19) United States
(12) Patent Application Publication
(10) Pub. No.: US 2025/0280094 A1
(43) Pub. Date: Sep. 4, 2025

(54) INFORMATION PROCESSING DEVICE, USER TERMINAL AND INFORMATION PROCESSING METHOD

(71) Applicant: MICWARE CO., LTD., Kobe-shi (JP)

(72) Inventor: Kenji NARUSHIMA, Kobe-shi (JP)

(21) Appl. No.: 19/214,046

(22) Filed: May 21, 2025

Related U.S. Application Data
(63) Continuation of application No. PCT/JP2022/048257, filed on Dec. 27, 2022.

(51) Int. Cl. H04N 7/18; G06T 11/60; H04N 7/025

(52) U.S. Cl. CPC H04N 7/181; G06T 11/60; H04N 7/025; H04N 7/185

(57) ABSTRACT

Conventionally, it is impossible to utilize the video captured by a mobile terminal of a performer during a performance of the performer. An information processing device 1 including: a video receiver 122 configured to receive a video from each of one or more mobile terminals installed on a performer; an inquiry receiver 123 configured to receive an inquiry from a user terminal 3; a video obtainer 133 configured to obtain the video corresponding to the performer satisfying the inquiry: and a video transmitter 142 configured to transmit the video obtained by the video obtainer 133 to the user terminal 3. Thus, the video captured by the mobile terminal of the performer can be utilized during the performance of the performer.

### CROSS-REFERENCE TO RELATED APPLICATIONS

This Application claims the benefit of priority and is a Continuation application of the prior International Patent Application No. PCT/JP2022/048257, with an international filing date of Dec. 27, 2022, which designated the United States, the entire disclosures of all applications are expressly incorporated by reference in their entirety herein.

### TECHNICAL FIELD

The present invention relates to an information processing device and the like configured to receive a video obtained by a camera installed on a performer such as a soccer player and an actor/actress and provide the video in response to an instruction from a user.

### BACKGROUND OF THE INVENTION

Conventionally, a technology for providing image data of on-vehicle camera captured at a position and an environment desired by a user is available (e.g., shown in Patent Document 1).

### PRIOR ART

### Patent Documents

[Patent Document 1] Japanese Patent Publication No. 2021-83034

### SUMMARY OF THE INVENTION

### Problem to be Solved by the Invention

However, in the conventional technology, it is impossible to utilize the video captured by a mobile terminal of a performer during a performance of the performer.

### Means for Solving the Problems

An information processing device of the first aspect of the present invention is the information processing device including: a video receiver configured to receive a video from each of one or more mobile terminals installed on a performer; an inquiry receiver configured to receive an inquiry from a user terminal; a video obtainer configured to obtain the video corresponding to the performer satisfying the inquiry; and a video transmitter configured to transmit the video obtained by the video obtainer to the user terminal.

The above described configuration allows to utilize the video captured by the mobile terminal of the performer during the performance of the performer.

An information processing device of the second aspect of the present invention is the information processing device according to the first aspect, further including: an attribute value obtainer configured to obtain an attribute value of the performer, wherein the inquiry receiver is configured to receive the inquiry including a performer condition related to the attribute value of the performer, the video obtainer is configured to obtain the video corresponding to the performer having the attribute value satisfying the performer condition, and the video transmitter is configured to transmit the video obtained by the video obtainer to the user terminal.

The above described configuration allows to utilize the video of an appropriate performer.

An information processing device of the third aspect of the present invention is the information processing device according to the first or second aspect, wherein the video receiver is configured to receive the video from a plurality of mobile terminals, the inquiry receiver is configured to receive the inquiry including a performer condition identifying a plurality of performers, the video obtainer is configured to obtain the video corresponding to each of the plurality of performers satisfying the performer condition, a video generator is further provided to generate one video using a plurality of videos obtained by the video obtainer, and the video transmitter is configured to transmit the video generated by the video generator to the user terminal.

The above described configuration allows to generate one video from the videos of a plurality of performers.

An information processing device of the fourth aspect of the present invention is the information processing device according to the third aspect, wherein the video generator is configured to generate the one video by combining the plurality of videos in a time series manner or by merging the plurality of videos in a spatial manner.

The above described configuration allows to generate one video from the videos of a plurality of performers.

An information processing device of the fifth aspect of the present invention is the information processing device according to any one of the first to fourth aspects, further including: a processor configured to accumulate the video received by the video receiver, wherein the video is associated with a time information which identifies a time when the video is captured, the inquiry receiver is configured to receive the inquiry including a time condition related to the time when the video is captured, the video obtainer is configured to obtain the video satisfying the time condition in the video accumulated in the processor, and the video transmitter is configured to transmit the video obtained by the video obtainer to the user terminal.

The above described configuration allows to utilize the video of the performer at an appropriate time.

An information processing device of the sixth aspect of the present invention is the information processing device according to any one of the first to fifth aspects, further including: a position receiver configured to receive one or more positional information from each of the one or more mobile terminals; an object generator configured to generate an operation object including the one or more positional information received by the position receiver for selecting the performer corresponding each of the one or more positional information; and an object transmitter configured to transmit the operation object to the user terminal, wherein the inquiry receiver is configured to receive the inquiry based on a selection of one or more performers with respect to the operation object, and the video obtainer is configured to obtain the video corresponding to the one or more performers satisfying the inquiry.

The above described configuration allows to assist the user choose the video easily.

An information processing device of the seventh aspect of the present invention is the information processing device according to any one of the first to sixth aspects, wherein the video obtained by the video obtainer is associated with a right holder identifier for identifying a right holder of the video, and a right holder processor is further provided to perform a right holder process which is a process related to the right holder identified by the right holder identifier associated with the video.

The above described configuration allows to perform appropriate processes related to the right holder of the video.

An information processing device of the eighth aspect of the present invention is the information processing device according to the seventh aspect, wherein the video is associated with a performer identifier for identifying the performer, the right holder processor includes a rewarding unit configured to perform a rewarding process which is a process of providing a reward to the performer identified by the performer identifier.

The above described configuration allows to provide the reward to the right holder of the video captured by the mobile terminal.

An information processing device of the ninth aspect of the present invention is the information processing device according to the eighth aspect, wherein the rewarding unit is configured to perform the rewarding process by determining the reward to the performer using a video attribute value corresponding to the video.

The above described configuration allows to provide an appropriate reward to the right holder of the video captured by the mobile terminal.

An information processing device of the tenth aspect of the present invention is the information processing device according to the seventh aspect, wherein the right holder processor includes a first preserver configured to perform a first preservation process which is a process of accumulating the video while being associated with an attribute value set.

The above described configuration allows to preserve the video.

An information processing device of the eleventh aspect of the present invention is the information processing device according to the seventh aspect, wherein the right holder processor includes a second preserver configured to perform a second preservation process which is a process of accumulating the video while being associated with the performer identifier.

The above described configuration allows to set an appropriate right holder to the right holder of the video.

An information processing device of the twelfth aspect of the present invention is the information processing device according to the seventh aspect, wherein the right holder processor includes a third preserver configured to accumulate the video while being associated with a right holder identifier for identifying a user of the user terminal.

The above described configuration allows to set the right holder requiring the video to the right holder of the video.

An information processing device of the thirteenth aspect of the present invention is the information processing device according to any one of the tenth to twelfth aspects, wherein the right holder processor includes a fourth preserver configured to perform a fourth preservation process which is a process of accumulating a preservation information including an access information for accessing the video in a blockchain.

The above described configuration allows to preserve the management information of the video requiring the preservation.

A user terminal of the fourteenth aspect of the present invention includes: a screen obtainer configured to obtain an operation screen indicating a position identified by a positional information of each of one or more mobile terminals installed on a performer; a screen output unit configured to output the operation screen; a user acceptor configured to accept a video instruction which is an instruction to the one or more mobile terminals in the operation screen; a user obtainer configured to obtain a video associated with the video instruction and captured by the one or more mobile terminals; and a user output unit configured to output the video obtained by the user obtainer.

The above described configuration allows the user to choose the video easily.

An user terminal of the fifteenth aspect of the present invention is the user terminal according to the fourteenth aspect, further including: a user receiver configured to receive the operation object from the information processing device, the screen obtainer is configured to obtain the operation screen using the operation object, the user obtainer is configured to generate an inquiry using the video instruction, transmit the inquiry to the information processing device, and receive the video from the information processing device when the inquiry is transmitted.

The above described configuration allows the user to choose the video easily.

### Effects of the Invention

The information processing device of the present invention allows to utilize the video captured by the mobile terminal of the performer during the performance of the performer.

### BRIEF DESCRIPTION OF DRAWINGS

FIG. 1 is a schematic diagram of an information system A in the first embodiment.

FIG. 2 is a block diagram of the information system A in the first embodiment.

FIG. 3 is a block diagram of an information processing device 1 in the first embodiment.

FIG. 4 is a flowchart for explaining an operation example of the information processing device 1 in the first embodiment.

FIG. 5 is a flowchart for explaining an example of a video transmitting process.

FIG. 6 is a flowchart for explaining an example of a video merging process.

FIG. 7 is a flowchart for explaining an example of a plural windows process.

FIG. 8 is a flowchart for explaining an example of an object generating process.

FIG. 9 is a flowchart for explaining an example of a past video transmitting process.

FIG. 10 is a flowchart for explaining an example of a preservation process in the first embodiment.

FIG. 11 is a flowchart for explaining an example of a fourth preservation process in the first embodiment.

FIG. 12 is a flowchart for explaining an example of a rewarding process in the first embodiment.

FIG. 13 is a flowchart for explaining an operation example of a mobile terminal 2 in the first embodiment.

FIG. 14 is a flowchart for explaining an operation example of a user terminal 3 in the first embodiment.

FIG. 15 is a drawing showing a terminal management table in the first embodiment.

FIG. 16 is a drawing showing a user management table in the first embodiment.

FIG. 17 is a drawing showing an example of an operation screen in the first embodiment.

FIG. 18 is a drawing showing an output example in the first embodiment.

FIG. 19 is a schematic external view of a computer system in the first embodiment.

FIG. 20 is a block diagram of the computer system in the first embodiment.

### DETAILED DESCRIPTION OF THE INVENTION

Hereafter, embodiments of an information processing device and other configurations will be explained with reference to the drawings. The repeated explanation of the components denoted with the same reference numerals may be omitted in the embodiments since the operations are the same.

### First Embodiment

### <Outline of First Embodiment>

The present embodiment explains an information processing device configured to receive a video captured by a camera installed on a performer and provide the video in response to an instruction from a user terminal. Note that the performer is, for example, athletes such as a soccer player and a baseball player, people such as an instrument player and an actor/actress carrying out a performance in public, jockeys, car racers or boat racers.

The present embodiment also explains an information processing device configured to transmit the video captured by a mobile terminal of each of one or more performers satisfying a performer condition to the user terminal.

The present embodiment also explains an information processing device configured to generate one video from the videos of a plurality of performers and transmit the one video to the user terminal. Note that the one video is the video formed by combining a plurality of videos in a time series manner or in a spatial manner.

The present embodiment also explains an information processing device configured to receive an inquiry including time information identifying a time and transmit a past video corresponding to the inquiry. Note that the past video is the video captured in the past and accumulated.

The present embodiment also explains an information processing device configured to receive a positional information of the performer, generate an operation object indicating a position of the performer indicated by the positional information, and transmit the operation object to the user terminal.

The present embodiment also explains an information processing device configured to perform a right holder process which is a process related to a right holder of the outputted video. The right holder process is, for example, the later-described rewarding process and the later-described various preservation processes. The right holder is, for example, the performer or the user requesting the video.

The present embodiment further explains a user terminal configured to output a screen for allowing a user to choose the video of the performer easily.

In the present embodiment, the fact that information X is associated with the information Y means that the information Y can be obtained from the information X or that the information X can be obtained from the information Y. The information X may be associated with the information Y in any manner. The information X and the information Y may be linked with each other or may be in the same buffer. The information X may be included in the information Y. The information Y may be included in the information X.

### <Outline of Information System A>

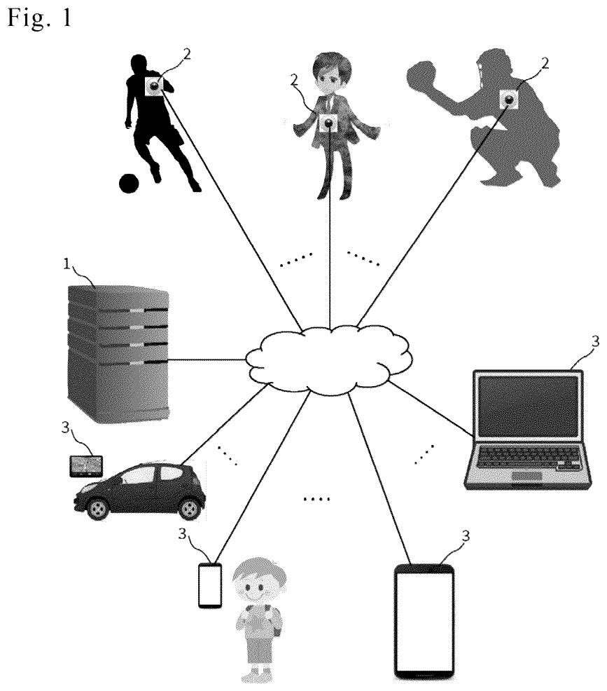

FIG. 1 is a schematic diagram of an information system A in the present embodiment. The information system A includes an information processing device 1, one or a plurality of mobile terminals 2 and one or a plurality of user terminals 3.

The information processing device 1 is a server for providing the videos transmitted by each of one or a plurality of mobile terminals 2 to the user terminal 3. The information processing device 1 is a cloud server or an application service provider (ASP) server, for example. The type of the information processing device 1 is not limited. The information processing device 1 may be a device included in a blockchain.

In the present specification, the interval of the capturing time between a plurality of still images included in the video is not limited. The video includes 60 frames per second or 30 frames per second, for example. However, the video may be a set of a plurality of still images captured at an interval equal to or longer than a predetermined time (e.g., one minute) or a set of a plurality of still images captured when a predetermined condition is satisfied. The still image may also be called a field or a frame.

The mobile terminal 2 is a movable terminal. The mobile terminal 2 is a terminal installed on the performer. The terminal installed on the performer is a terminal installed on an object (e.g., glasses, uniform, helmet) worn by the performer or a terminal installed on an object (e.g., automobile, motorcycle) operated by the performer. The mobile terminal 2 is the terminal capturing videos. The mobile terminal 2 is, for example, a smartphone, a tablet terminal, a camera with a communication function, glasses with a camera or a smartwatch with a camera. The installation normally means the condition where something is fastened. However, it is also possible to consider that the installation includes the situation where something is contacted or held.

The user terminal 3 is a terminal used by a user. The user is a person who views the video or a person who requires the video. The user terminal 3 may have the function of the mobile terminal 2. Namely, the user terminal 3 may be the terminal of the user who provides the video. The user terminal 3 is, for example, a smartphone, a tablet terminal, a so-called personal computer, a navigation terminal or the like. The type of the user terminal is not limited.

The information processing device 1 and each of one or more mobile terminals 2 can generally communicate with each other through a network such as the Internet. The information processing device 1 and each of one or more user terminals 3 can generally communicate with each other through a network such as the Internet.

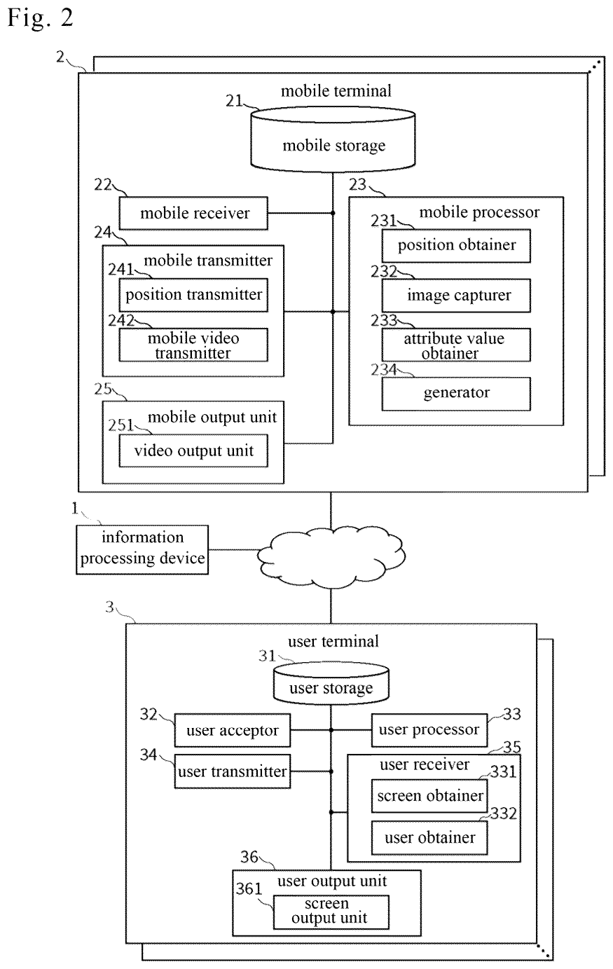

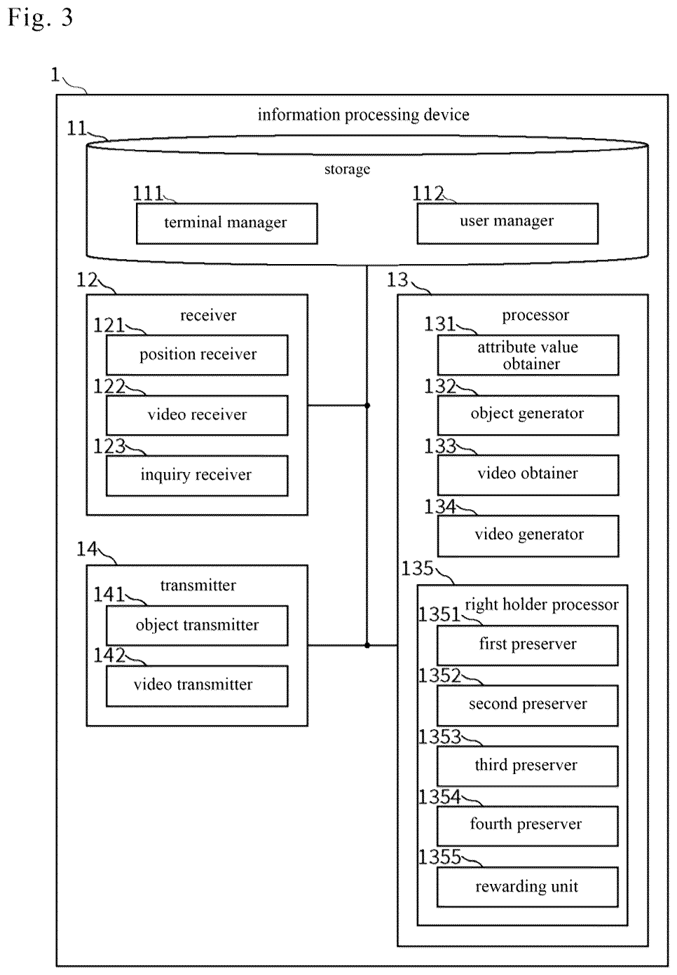

FIG. 2 is a block diagram of the information system A in the present embodiment. FIG. 3 is a block diagram of the information processing device 1.

The information processing device 1 includes a storage (storage unit) 11, a receiver (reception unit) 12, a processor (processing unit) 13 and a transmitter (transmission unit) 14. The storage 11 includes a terminal manager (terminal management unit) 111 and a user manager (user management unit) 112. The receiver 12 includes a position receiver (position reception unit) 121, a video receiver (video reception unit) 122 and an inquiry receiver (inquiry reception unit) 123. The processor 13 includes an attribute value obtainer (attribute value obtaining unit) 131, an object generator (object generation unit) 132, a video obtainer (video obtaining unit) 133, a video generator (video generation unit) 134 and a right holder processor (right holder processing unit) 135. The right holder processor 135 includes a first preserver (first preservation unit) 1351, a second preserver (second preservation unit) 1352, a third preserver (third preservation unit) 1353, a fourth preserver (fourth preservation unit) 1354 and a rewarding unit 1355. The transmitter 14 includes an object transmitter (object transmission unit) 141 and a video transmitter 142 (video transmission unit).

The mobile terminal 2 includes a mobile storage (mobile storage unit) 21, a mobile receiver (mobile reception unit) 22, a mobile processor (mobile processing unit) 23, a mobile transmitter (mobile transmission unit) 24 and a mobile output unit 25. The mobile processor 23 includes a position obtainer (position obtaining unit) 231, an image capturer (image capturing unit) 232, an attribute value obtainer (attribute value obtaining unit) 233 and a generator (generation unit) 234. The mobile transmitter 24 including a position transmitter (position transmission unit) 241 and a mobile video transmitter (mobile video transmission unit) 242. The mobile output unit 25 includes a video output unit 251.

The user terminal 3 includes a user storage (user storage unit) 31, a user acceptor (user acceptance unit) 32, a user processor (user processing unit) 33, a user transmitter (user transmission unit) 34, a user receiver (user reception unit) 35 and a user output unit 36. The user processor 33 includes a screen obtainer (screen obtaining unit) 331 and a user obtainer (user obtaining unit) 332. The user output unit 36 includes a screen output unit 361.

### <Detail of Components of Information Processing Device 1>

The storage 11 stores various kinds of information. The various kinds of information are, for example, the later-described terminal information, the later-described user information, a video and an additional video. The additional video is the video and one or a plurality of video attribute values associated with the video. The additional video is preferably the video associated with one or more video attribute values. The additional video is preferably associated with a terminal identifier.

The video attribute value is an attribute value of the video. The video attribute value is, for example, an environment information. The environment information is the information about the environment where the video is captured. The environment information is, for example, the later described positional information and time information. The environment information may include, for example, weather information, temperature information, season information and the like. The time information is the information for identifying the time when the video is captured. The time when the video is captured may be the time around the time when the video is captured. The accuracy is not required for the time when the video is captured. The time information is, for example, a time, a set of year, month, day and hour, a set of year, month, day, hour and minute, a set of year, month, day, hour, minute and second, a set of year, month and day or a set of month and day. Namely, the time information may indicate the time with any granularity. The weather information is the information for identifying the weather at the location (or region) where the video is captured and at the time when the video is captured. The weather information is, for example, “sunny,” “rainy,” “snowy” or “cloudy.” The temperature information is the information for identifying a temperature at the location where the video is captured and at the time when the video is captured. The temperature information is, for example, “25 degrees” or “30 degrees or higher.” The season information is the information for identifying the season at the location where the video is captured and at the time when the video is captured. The season information is, for example, “spring,” “summer,” “early summer” or “winter.”

The video attribute value may be a tag. The tag is the information indicating the content of the video. The tag is preferably the result analyzing one or more still images included in the video. The tag is, for example, “goal” which indicates the fact that a goal is scored in a soccer game or “home run” which indicates the fact that a home run is hit in a baseball game.

The terminal manager 111 stores one or a plurality of terminal information. The terminal information is the information related to the mobile terminal 2. The terminal information here normally includes a terminal identifier which is an identifier of the mobile terminal 2 and one or a plurality of positional information. The one or more positional information is preferably the latest positional information of the mobile terminal 2. The terminal information may include a terminal communication information. The terminal information may include one or more attribute values.

The terminal identifier is the information for identifying the mobile terminal 2. The terminal identifier may be a performer identifier for identifying the performer which is a user of the mobile terminal 2. The terminal identifier is, for example, an identification (ID) of the mobile terminal 2, a name of the mobile terminal 2, an IP address of the mobile terminal 2 or a media access control (MAC) address of the mobile terminal 2. The performer identifier is, for example, an identification (ID) of the performer, a name of the performer, a mail address of the performer or a telephone number of the performer.

The positional information is the information for identifying the position. The positional information is, for example, a set of a latitude and a longitude or a set of a latitude, a longitude and an altitude. The positional information may be, for example, the information indicating a relative position of the place (e.g., soccer ground) where a competition is held.

The terminal communication information is the information for communicating with the mobile terminal 2. The terminal communication information is, for example, an IP address of the mobile terminal 2, a media access control (MAC) address of the mobile terminal 2, or an identification (ID) of a communication application installed on the mobile terminal 2.

The attribute value is the attribute value of the performer. The attribute value is, for example, a static attribute value or a dynamic attribute value. The static attribute value is a static attribute value of the performer. The static attribute value is, for example, a position (e.g., “keeper,” “forward,” “catcher”) in soccer or baseball, or an instrument played by an instrument player. The dynamic attribute value is the dynamically changed attribute value during the performance. The dynamic attribute value is, for example, the positional information of the performer, a role (e.g., “ball possessor,” “penalty kick kicker,” “batter,” “pitcher”) during the game of soccer, baseball or the like, or the information indicating whether or not the performer possesses the ball.

The user manager 112 stores one or a plurality of user information. The user information is the information related to the user. The user information includes, for example, a user identifier. The user information includes, for example, a performer condition. The user information includes, for example, one or a plurality of user attribute values.

The user identifier is the information for identifying the user. The user identifier is, for example, an identification (ID), a telephone number, a mail address, a name or an identifier of the user terminal 3. The identifier of the user terminal 3 is, for example, an IP address or a media access control (MAC) address.

The performer condition is the condition for determining the video provided to the user. The performer condition is, for example, an attribute value condition or an identification condition. The attribute value condition is the condition related to the attribute value of the performer. The attribute value condition is, for example, “goalkeeper,” “penalty kick kicker” or “ball possessor.” The identification condition is the condition for identifying a particular performer. The identification condition normally includes one or a plurality of performer identifiers. The identification condition is, for example, “performer identifier=101” or “performer identifier=101, 102.”

The user attribute value is, for example, a gender, an age or payment information. The payment information is the information for paying the fee for the use of the service such as a video viewing and a video purchasing. The payment information is, for example, a bank account number, a credit card number or an identification (ID) of a payment application.

The receiver 12 receives various kinds of information and instructions from the mobile terminal 2 or the user terminal 3. The various kinds of information and instructions are, for example, the positional information, the inquiry, the video, the later described additional video, the later described finish instruction or the later described purchase instruction.

The receiver 12 may receive the video while being paired with the positional information from each of one or a plurality of mobile terminals 2. In the above described case, it is preferable that the receiver 12 receives the video continuously. To receive the video continuously is, for example, to receive the video periodically or receive the video all of the time. The concept of “periodically” may include certain difference of the intervals.

For example, the receiver 12 continuously receives the positional information of the ball in the game. In the above described case, a module for obtaining the positional information and transmitting the positional information is embedded in the ball.

The position receiver 121 receives the positional information from each of one or more mobile terminals 2. It is preferred that the position receiver 121 continuously receives the latest positional information from one or a plurality of mobile terminals 2. The position receiver 121 may receive one or a plurality of positional information sets corresponding to the video stored in the mobile terminal 2 from the mobile terminal 2. The position receiver 121 normally receives the positional information while being associated with the terminal identifier. Note that the positional information is preferably associated with one or a plurality of till images in the video.

The video receiver 122 receives the video from each of one or more mobile terminals 2 installed on the performer. The video receiver 122 preferably receives the video from each of a plurality of mobile terminals 2. It is preferable that the video receiver 122 continuously receives the video from each of one or more mobile terminals 2. It is preferable that one or more video attribute values are associated with the above described video. Normally, the positional information and the performer identifier are associated with the above described video. It is preferable that the time information is associated with the video.

The inquiry receiver 123 receives the inquiry from the user terminal 3. The inquiry is the request for the video. The inquiry normally includes the performer condition. The inquiry may be the inquiry for obtaining a current video while the inquiry may be the inquiry for obtaining a past video. The inquiry may include the performer condition for identifying a plurality of performers. The inquiry may include a time condition related to the time when the video is captured. The inquiry is preferably based on the choice of one or more performers with respect to the operation object outputted from the user terminal 3.

The current video is the video transmitted immediately after the video is captured by the mobile terminal 2. The past video is the video captured by the mobile terminal 2 in the past, received by the information processing device 1 and accumulated in a recording medium once.

The processor 13 performs various kinds of processes. The various kinds of processes are, for example, the process performed by the attribute value obtainer 131, the object generator 132, the video obtainer 133, the video generator 134 and the right holder processor 135. For example, the processor 13 accumulates the video received by the video receiver 122.

The attribute value obtainer 131 obtains one or a plurality of attribute values of the performer. The attribute value is the static attribute value or the dynamic attribute value.

For example, the attribute value obtainer 131 reads the static attribute value associated with the mobile terminal 2 out of the terminal manager 111. The fact that the static attribute value is associated with the mobile terminal 2 normally means that the static attribute value is associated with the performer identifier.

The attribute value obtainer 131 obtains, for example, the dynamic attribute value. For example, the attribute value obtainer 131 obtains the attribute value “ball possessor” of the performer identified by the performer identifier paired with the positional information satisfying an approximate condition with respect to the received positional information of the ball while being paired with the performer identifier. The approximate condition is, for example, two positional information are within a threshold value or the positional information having the minimum distance from the positional information of the ball.

For example, the attribute value obtainer 131 obtains the attribute value “penalty kick kicker” of the performer associated with the positional information satisfying the approximate condition with respect to the positional information of the position where the penalty kick is kicked. For example, when the attribute value obtainer 131 detects that a state where the difference between the received positional information of the ball and the positional information of the position where the penalty kick is kicked is within a threshold value (e.g., within 30 cm) is continued for a threshold time or more, the attribute value obtainer 131 obtains the attribute value “penalty kick kicker” of the performer associated with the positional information satisfying the approximate condition with respect to the positional information of the position where the penalty kick is kicked. It is assumed that the positional information of the position where the penalty kick is kicked is preliminarily stored in the storage 11.

For example, the attribute value obtainer 131 may perform the process same as the later described process of obtaining the tag from the video by the attribute value obtainer 233.

The object generator 132 generates the operation object including one or a plurality of positional information of the performer received by the position receiver 121 for choosing the performer corresponding to each of the one or a plurality of positional information. The operation object is, for example, the screen or the window including a movable object (e.g., button) for selecting each of one or more positional information received by the position receiver 121.

The video obtainer 133 obtains the video corresponding to each of one or a plurality of performers satisfying the received inquiry. Note that the performer satisfying the inquiry can be referred to as the mobile terminal 2 satisfying the inquiry. The video corresponding to the performer is the video transmitted from the mobile terminal 2 of the performer.

The video obtainer 133 preferably obtains the video corresponding to the performer having the attribute value satisfying the performer condition. The video obtainer 133 may obtain the video corresponding to each of a plurality of performers satisfying the performer condition.

The video obtainer 133 obtains the past video satisfying the inquiry in the past videos accumulated in the processor 13. The video obtainer 133 may obtain the past video satisfying the time condition in the past videos accumulated in the processor 13. For example, the video obtainer 133 obtains the past video before and after X seconds from the time identified by the time condition for identifying the time of scoring a goal by a player A in the accumulated past videos.

The video generator 134 generates one video using a plurality of videos obtained by the video obtainer 133.

For example, the video generator 134 combines each of a plurality of videos obtained by the video obtainer 133 in a time series manner to generate one video. Each of a plurality of videos is preferably the video captured by different mobile terminals 2 from each other. Note that the one video combined in a time series manner is one video formed by combining a plurality of source videos. When a plurality of videos, which is a source of one video combined in a time series manner, is captured, it is preferred that the videos are continued in a time series manner. However, the videos may be separated from each other. For example, one source video (source of one video) may be captured at 8:20 while the other source video (source of one video) may be captured at 8:25. The plurality of videos which is a source of one video combined in a time series manner is, for example, the video associated with the attribute value “ball possessor.” The combined one video in a time series manner is appropriately referred to as a combined video.

For example, the video generator 134 merges each of a plurality of videos obtained by the video obtainer 133 in a spatial manner to generate one video. The one video merged in a spatial manner is the video generated by constituting frames using a part or an entire of frames of each of the source videos and connecting the frames in a time series manner. Note that at least one frame constituting the one video is the frame including a part or an entire of the frames of each of the source videos. The one video merged in a spatial manner is approximately referred to as a merged video.

The process of merging the frames included in each of a plurality of videos in a spatial manner is, for example, the following processes (a) (b).

### (a) Method Based on Image Processing

For example, the video generator 134 performs the process of matching the direction of each of a plurality of frames as the object of connecting the videos in a spatial manner. Then, the video generator 134 detects identical regions in each of a plurality of frames, for example. Then, the video generator 134 performs the process of overlapping a plurality of frames having the identical regions with each other to generate one frame with a wide area, for example. Note that it is possible to detect the identical regions in a plurality of frames using the conventionally known technology.

### (b) Method Based on Machine Learning

For example, the video generator 134 gives a plurality of frames and learning models to the module for performing the prediction processing of the machine learning, executes the module, and obtains one frame with a wide area.

Note that the learning model is obtained by using a plurality of frames as an explanatory variable, giving a plurality of teacher data using one frame with a wide area generated from the plurality of frames as an objective variable to the module performing the learning process of the machine learning and executing the module.

The learning model may be also referred to as a learning device, a classifier, a classification model or the like. The algorithm of the machine learning is not limited. Although the deep learning is preferable, the random forest or other algorithms can be also used. For example, various existing functions and libraries of the machine learning such as a library of TensorFlow and a module of random forest of R language can be used for the machine learning.

The video generator 134 may perform the process of transmitting the one video obtained by the video obtainer 133 to the video transmitter 142. It can be considered that the above described process is the process of generating one video. The process of transmitting the one video to the video transmitter 142 is normally the process of sequentially arranging the videos in a buffer for transmitting the video.

The right holder processor 135 performs the right holder process. The right holder process is the process about the right holder identified by the right holder identifier associated with the video. Note that the right holder identifier is normally the performer identifier. However, the right holder identifier may be the user identifier. For example, the right holder processor 135 performs the right holder process which is the process performed in response to the transmission of the video from the video transmitter 142 and the process about the right holder identified by the right holder identifier associated with the video. For example, the right holder process is the later-described first preservation process, the later-described second preservation process, the later-described third preservation process, the later-described fourth preservation process and the later-described rewarding process.

Note that the right holder identifier associated with one video is, for example, the right holder identifier associated with each of one or a plurality of videos which is the source of the generated one video (combined video or merged video) or an identifier of the user who request the one video. The user who requested one video is the user of the user terminal 3 which transmitted the inquiry.

The first preserver 1351 performs the first preservation process of accumulating one video generated by the video generator 134 while being associated with the attribute value set associated with each of one or a plurality of videos which is the source of the one video. The first preserver 1351 may perform the first preservation process of accumulating the video received from the mobile terminal 2 while being associated with the attribute value set associated with the video. Note that the attribute value set is one or more mobile attribute values.

The second preserver 1352 performs the second preservation process of accumulating one video generated by the video generator 134 while being associated with the right holder identifier corresponding to each of one or a plurality of videos which is the source of the one video.

Note that the first preserver 1351 or the second preserver 1352 may accumulate one video generated by the video generator 134 while being associated with the attribute value set associated with each of one or a plurality of videos which is the source of the one video and associated with the right holder identifier corresponding to each of one or a plurality of videos which is the source of the one video.

The third preserver 1353 accumulates the one video generated by the video generator 134 while being associated with the right holder identifier for identifying the user of the user terminal 3. Note that the user of the user terminal 3 here is the person viewing one video. The user terminal 3 here is, for example, the terminal from which the inquiry is transmitted. The right holder identifier here is the user identifier.

The destination in which one video is accumulated is, for example, the storage 11. However, one video may be accumulated in the other devices included in a blockchain.

The fourth preserver 1354 performs the fourth preservation process of accumulating a preservation information. The preservation information includes the access information for accessing the accumulated one video. The process of accumulating the videos and the fourth preservation process of the preservation information corresponding to the video may be performed in any order.

For example, the fourth preserver 1354 performs the fourth preservation process of accumulating the preservation information generated and accumulated in the video generator 134 in a blockchain. Here, the preservation information includes the access information for accessing the accumulated one video.

Note that the fourth preserver 1354 preferably accumulates the preservation information in a blockchain. Namely, the fourth preserver 1354 preferably accumulates the preservation information in a distributed ledger in a blockchain. The fourth preserver 1354 preferably registers the preservation information as an NFT (non-fungible token). The fourth preserver 1354 preferably registers the preservation information in a distributed file system in an IPFS (Inter Planetary File System) network.

The preservation information is the information for retaining the originality of the video. The preservation information is, in other words, the headline information of the video. The preservation information is, for example, the access information and the attribute value set. The preservation information preferably includes one or a plurality of right holder identifiers, for example. When the preservation information includes a plurality of right holder identifiers, the video may be shared by the right holders and the plurality of right holder identifiers may be right holder history information. The right holder history information is a set of the right holder identifiers and the information indicating the history of right holder changes. The fourth preservation process guarantees the originality of the preservation information of the registered video. The guarantee of the originality of the preservation information also guarantees the originality of the video corresponding to the preservation information. Note that the access information is the information for accessing the video. The access information is the information for identifying the destination in which the video is accumulated. The access information is, for example, URL and URI.

The preservation information preferably includes the information (also referred to a flag) indicating whether or not the video can be provided to a third party. The flag is, for example, the information indicating that the video is viewable by a third party, that the video may be for sale or that the video is neither viewable nor for sale.

The rewarding unit 1355 performs the rewarding process for each of right holders identified by the right holder identifier associated with each of one or a plurality of videos which is the source of the one video generated by the video generator 134.

The rewarding process is a process of providing a reward. For example, the rewarding process is the process of increasing points managed in a manner paired with each of one or a plurality of right holder identifiers associated with the video. For example, the rewarding process is the process of paying money to the right holder identified by each of one or a plurality of right holder identifiers associated with the video. For example, the rewarding process is the process of transmitting the video or other contents to the user terminal 3 of the right holder identified by each of one or a plurality of right holder identifiers associated with the video. The rewarding process may be any processes of providing a merit to the right holder identified by each of one or a plurality of right holder identifiers associated with the video. The content of the rewarding process is not limited. The reward may be provided in any form, including money, points, products, and contents. The content of the reward is not limited.

It is preferred that the rewarding unit 1355 obtains one or a plurality of video attribute values associated with each of one or a plurality of videos which is transmitted by the video transmitter 142 and is the source of one video, determines the reward to each of the plurality of right holders using the one or more video attribute values and performs the rewarding process which is the process of providing the reward.

Here, one or more video attribute values are, for example, the data amount of the video, the time of the video, the number of frames of the video and the resolution of the video.

The rewarding unit 1355 preferably obtains a reward amount corresponding to a service identifier for identifying the service performed on the target video and performs the rewarding process which is the process of providing the reward corresponding to the reward amount. Note that the service identifier is, for example, “viewing” and “purchasing.” In the above described case, the storage 11 stores the information for determining the reward amount corresponding to the service identifier or the reward amount corresponding to the service identifier.

For example, the rewarding unit 1355 obtains the reward amount and performs the rewarding process which is the process of providing the reward corresponding to the reward amount using one or a plurality of information of one or a plurality of video attribute values and service identifiers. In the above described case, an arithmetic expression or a table corresponding to each of a plurality of service identifiers is stored in the storage 11, for example. The arithmetic expression is the expression for calculating the reward amount using one or a plurality of video attribute values as parameters. The table includes a plurality of correspondence information for managing the reward amount corresponding to one or a plurality of video attribute values.

The rewarding unit 1355 normally performs the process of causing the user that has enjoyed the service relevant to the target video to pay the reward. The process of causing the user to pay the reward is, for example, the process of causing the user to pay the obtained reward amount. The process of causing the user to pay the reward is, for example, the process of causing the user to pay the obtained reward amount and the profit obtained by the management side of the information processing device 1. The process of causing the user to pay the reward is, for example, the process of reducing the points corresponding to the user receiving the service or the settlement process using the credit card number of the corresponding user.

The transmitter 14 transmits various kinds of information and instructions to the mobile terminal 2 or the user terminal 3. The various kinds of information and instructions are, for example, the operation object and the video. Note that the video may be the additional video.

The object transmitter 141 transmits the operation object generated by the object generator 132 to the user terminal 3.

The video transmitter 142 transmits the video obtained by the video obtainer 133 to the user terminal 3. The above described user terminal 3 is normally the user terminal 3 from which the inquiry is transmitted. The video transmitter 142 preferably transmits the video generated by the video generator 134 to the user terminal 3.

### <Detail of Components of Mobile Terminal 2>

The mobile storage 21 stores various kinds of information. The various kinds of information are, for example, the video, the attribute value set, the performer identifier and the camera attribute value. The camera attribute value is the attribute value of the camera. The camera attribute value is, for example, an angle of view, a direction information and a resolution.

For example, one or more video attribute values included in the attribute value set is associated with one or more still images included in the video. One or more video attribute values may be associated with all still images, associated with a part of the still images, or associated with a plurality of still images.

The mobile receiver 22 receives various kinds of information. The various kinds of information are, for example, a transmission instruction. A movement instruction receiver 221 receives the transmission instruction from the information processing device 1. The transmission instruction is the instruction for transmitting the video.

The mobile processor 23 performs various kinds of processes. The various kinds of processes are, for example, processes performed by the position obtainer 231, the image capturer 232, the attribute value obtainer 233 and the generator 234. Note that the mobile processor 23 may not include the attribute value obtainer 233 and the generator 234.

The position obtainer 231 obtains the positional information. The position obtainer 231 normally obtains the positional information for identifying the position of the mobile terminal 2. The position obtainer 231 obtains the positional information by a GPS receiver, for example. However, the method and the algorithm of obtaining the positional information by the position obtainer 231 are not limited.

The image capturer 232 captures the video. For example, the image capturer 232 captures the video during the movement of the mobile terminal 2. Note that the positional information obtained by the position obtainer 231 is preferably associated with the captured video. One or more video attribute values obtained by the later described attribute value obtainer 233 are preferably associated with the captured video. Note that during the movement of the mobile terminal 2 is during the movement of the performer.

The image capturer 232 preferably accumulates the captured video in the mobile storage 21. The image capturer 232 preferably overwrites the area storing old video with new video when the storage capacity of the mobile storage 21 for accumulating the video is limited. Namely, the mobile storage 21 preferably has a ring buffer structure.

The attribute value obtainer 233 obtains one or more camera attribute values including the direction information indicating the direction capturing the image capturer 232. The attribute value obtainer 233 preferably obtains one or a plurality of video attribute values including the camera attribute value.

The attribute value obtainer 233 obtains, for example, one or more video attribute values. The one or a plurality of video attribute values can be referred to as the attribute value set.

The attribute value obtainer 233 obtains, for example, the time information which is the time from a not-illustrated clock. The attribute value obtainer 233 obtains, for example, the time information which is the lapse time from the start of the game from a not-illustrated timer. The attribute value obtainer 233 obtains, for example, the time information continuously, at predetermined intervals, or when the obtaining condition is satisfied.

The attribute value obtainer 233 obtains, for example, the time information from a not-illustrated clock during video capturing, and obtains the season information corresponding to the time information. The attribute value obtainer 233 obtains, for example, the weather information during video capturing. Even when the video is captured indoors, the weather information may be the information of the weather at the region similar to the indoors. The mobile processor 23 obtains, for example, the weather information corresponding to the positional information from a not-illustrated server. The mobile processor 23 obtains, for example, the weather information continuously, at predetermined intervals, or when the obtaining condition is satisfied. The attribute value obtainer 233 obtains, for example, the temperature information during video capturing. The mobile processor 23 obtains, for example, the temperature information corresponding to the positional information from a not-illustrated server. The mobile processor 23 obtains, for example, the temperature information from a temperature sensor installed on the movable body. The mobile processor 23 obtains, for example, the temperature information continuously, at predetermined intervals, or when the obtaining condition is satisfied. Note that the obtaining condition is, for example, when the analysis result of the video satisfies a predetermined condition.

The attribute value obtainer 233 obtains, for example, one or more tags corresponding to the video captured by the image capturer 232 and associates the one or more tags with the video. Note that it can be said that the tag is also the video attribute value.

For example, the attribute value obtainer 233 analyzes the video captured by the image capturer 232 and obtains one or more tags corresponding to the video.

For example, the attribute value obtainer 233 determines one or more still images satisfying the video tag condition and obtains the tag paired with the video tag condition. The attribute value obtainer 233 may associate the tag with one or more still images. Note that the still images are frames included in the video.

For example, when the video tag condition is “the size of the ball in the still image is a threshold value of more,” the attribute value obtainer 233 analyzes the frame included in the video, recognizes the ball, obtains the size of the ball and determines whether or not the size satisfies the video tag condition. When the video tag condition is satisfied, the attribute value obtainer 233 obtains the tag “ball possessor” which is paired with the video tag condition. The attribute value obtainer 233 may associate the tag “ball possessor” with the analyzed frame of the video.

The generator 234 associates the obtained positional information with the video and obtains the additional video. Note that the operation of associating something with the video is normally the operation of associating something with one or more still images in the video. For example, the generator 234 associates the obtained positional information with one or more still images obtained at the same time when the positional information is obtained.

For example, the generator 234 obtains the additional video in which one or more camera attribute values obtained by the attribute value obtainer 233 are also associated with the video.

For example, the generator 234 obtains the additional video in which one or more video attribute values obtained by the attribute value obtainer 233 are also associated with the video. The additional video is the video to which one or more video attribute values are added. The above described one or more video attribute values normally include the positional information. Each of one or more video attribute values is normally associated with one or more still images in the video.

The mobile transmitter 24 transmits various kinds of information to the information processing device 1. The various kinds of information are, for example, the positional information, the video and the additional video. The mobile transmitter 24 preferably transmits the video obtained by the image capturer 232 continuously to the information processing device 1. In the above described case, the positional information and the performer identifier are preferably associated with the video.

The position transmitter 241 transmits the positional information obtained by the position obtainer 231 to the information processing device 1. The performer identifier is normally associated with the above described positional information.

It is preferred that the position transmitter 241 continuously transmits the positional information to the information processing device 1. The concept of “continuously” includes the concepts of “always” and “periodically.” The concept of “periodically” means that the transmission interval may be slightly varied. The frequency and the interval of transmitting the positional information by the position transmitter 241 are not limited.

The mobile video transmitter 242 transmits the video. It is preferred that the mobile video transmitter 242 continuously transmits the video to the information processing device 1. The above described video may be the additional video. The performer identifier is normally associated with the video.

The mobile video transmitter 242 may transmit the video captured by the image capturer 232 when the movement instruction receiver 221 receives the transmission instruction.

The mobile output unit 25 outputs various kinds of information. The various kinds of information are, for example, the video, the additional video and the attribute value set. Note that the mobile terminal 2 may not include the mobile output unit 25.

The output is the concept including the operation of displaying on a display, the operation of projecting with a projector, the operation of printing with a printer, the operation of outputting sound, the operation of transmitting to an external device, the operation of accumulating in a recording medium, and the operation of delivering a processed result to another processor or another program.

The video output unit 251 outputs the video. The video output unit 251 preferably outputs the additional video. The output here may be the accumulation in the mobile storage 21.

### <Detail of Components of User Terminal 3>

The user storage 31 stores various kinds of information. The various kinds of information are, for example, the user identifier, the video, the inquiry and the background information.

The background information is the information including the information for generating the image of the place where the performer gives a performance. The background information includes, for example, a background image of the soccer ground and a background image of a baseball park. The background information includes, for example, an object for inputting the performer condition. The object is, for example, a button, a checkbox and a menu item. The background information is, for example, an image. However, the data type of the background information is not limited.

The user acceptor 32 accepts various kinds of instructions and information. The various kinds of instructions and information are, for example, the inquiry, the video instruction and the finish instruction. Note that the inquiry may include the video instruction or the purchase instruction.

The acceptance is the concept including the acceptance of the information inputted from input devices such as a keyboard, a mouse and a touch panel, the reception of the information transmitted via a communication line with wired or wireless communication, and the acceptance of the information read from recording media such as an optical disk, a magnetic disk and a semiconductor memory.

The various kinds of instructions and information may be input in any manner, such as with a touch panel, a keyboard, a mouse and a menu screen.

The inquiry may include a transfer flag of the right holder. The transfer flag of the right holder is the information indicating the transfer of the right holder of the video.

The video instruction is the instruction for outputting the video. The video instruction is the instruction transmitted to the mobile terminal 2 in the operation screen. The video instruction normally includes the performer condition. Note that the mobile terminal 2 in the operation screen can be referred to as the performer in the operation screen.

The finish instruction is the instruction for finishing to transmit the video.

The purchase instruction is the instruction for purchasing the video. The purchase instruction is associated with the user identifier. The purchase instruction normally includes the information identifying the video. The purchase instruction includes, for example, a video identifier. The purchase instruction includes, for example, a time information. The purchase instruction includes, for example, an inquiry. The purchase instruction includes, for example, a purchase condition. The purchase condition is, for example, a purchase price. The purchase condition includes, for example, the information identifying a right period.

The user processor 33 performs various kinds of processes. The various kinds of processes are, for example, the processes related to the data structure for transmitting various kinds of instructions and information received by the user acceptor 32. The various kinds of processes are, for example, the processes related to the structure of transmitting the information received by the user receiver 35.

The user processor 33 generates the inquiry including the performer identifier associated with the video instruction as the performer condition using the accepted video instruction.

When the video instruction of the screen based on the operation object is accepted, the user processor 33 generates the inquiry including the flag of obtaining a realtime video, for example.

When the video instruction of the screen based on the operation object is accepted, the user processor 33 generates the inquiry including the flag of obtaining a past video, for example.

The screen obtainer 331 obtains the operation screen indicating the position identified by the positional information of each of one or more mobile terminal 2. The screen obtainer 331 obtains, for example, the operation screen using the received operation object. For example, the screen obtainer 331 generates the screen indicating one or more received positional information on the background information of the user storage 31.

The user obtainer 332 obtains the video captured by the mobile terminal 2 with respect to the video instruction received by the user acceptor 32. The user obtainer 332 obtains, for example, the video received by the user receiver 35.

The user obtainer 332 generates, for example, the inquiry using the video instruction received by the user acceptor 32. Then, the user obtainer 332 transmits, for example, the inquiry to the information processing device 1. Then, the user obtainer 332 receives, for example, the video from the information processing device 1 when the inquiry is transmitted.

The user transmitter 34 transmits various kinds of instructions and information to the information processing device 1. The various kinds of instructions and information are, for example, the inquiry, the video instruction, the finish instruction and the purchase instruction.

The user receiver 35 receives the operation object from the information processing device 1.

The user receiver 35 receives the video when the inquiry is transmitted. The user receiver 35 normally receives the video from the information processing device 1. Note that the video may be the additional video.

The user output unit 36 outputs the video captured by the user obtainer 332. The user output unit 36 outputs, for example, the video received by the user receiver 35.

The output here is the concept including the operation of displaying on a display, the operation of projecting with a projector, the operation of printing with a printer, the operation of outputting sound, the operation of transmitting to an external device, the operation of accumulating in a recording medium, and the operation of delivering a processed result to another processor or another program.

The screen output unit 361 outputs the operation screen obtained by the screen obtainer 331.

The storage 11, the terminal manager 111, the mobile storage 21 and the user storage 31 are preferably a nonvolatile recording medium. However, these storages may be a volatile recording medium.

The process of storing the information in the storage 11 or the like is not limited. For example, the information may be stored in the storage 11 or the like via a recording medium, the information transmitted via a communication line or the like may be stored in the storage 11 or the like, or the information inputted by an input device may be stored in the storage 11 or the like.

The receiver 12, the position receiver 121, the video receiver 122, the inquiry receiver 123, the mobile receiver 22 and the user receiver 35 are normally implemented by a wireless or wired communication means. However, these receivers may be implemented by a means for receiving a broadcast.

The processor 13, the attribute value obtainer 131, the object generator 132, the video obtainer 133, the video generator 134, the right holder processor 135, the first preserver 1351, the second preserver 1352, the third preserver 1353, the fourth preserver 1354, the rewarding unit 1355, the mobile processor 23, the user processor 33, the screen obtainer 331 and the user obtainer 332 may normally be implemented by a processor, a memory or the like. The processing procedure of the processor 13 or the like is normally implemented by a software and the software is stored in a recording medium such as a read-only memory (ROM). However, the processing procedure may be implemented by a hardware (dedicated circuit). Note that the processor is a central processing unit (CPU), a microprocessor unit (MPU), a graphical processing unit (GPU) or the like. The type of the processor is not limited.

The transmitter 14, the object transmitter 141, the video transmitter 142, the mobile transmitter 24, the position transmitter 241, the mobile video transmitter 242 and the user transmitter 34 are normally implemented by a wireless or wired communication means. However, these transmitters may be implemented by a broadcast means.

The position obtainer 231 is achieved, for example, by a GPS receiver.

The image capturer 232 includes a camera capable of capturing the video. Note that the type of the camera is not limited.

The mobile output unit 25, the video output unit 251, the user output unit 36 and the screen output unit 361 may or may not include an output device such as a display and a speaker. The mobile output unit 25 may be implemented by a driver software of an output device or implemented by a driver software of an output device and the output device, for example.

The user acceptor 32 may be implemented by a device driver of an input device such as a touch panel and a keyboard or a control software of a menu screen, for example.

### <Operation>

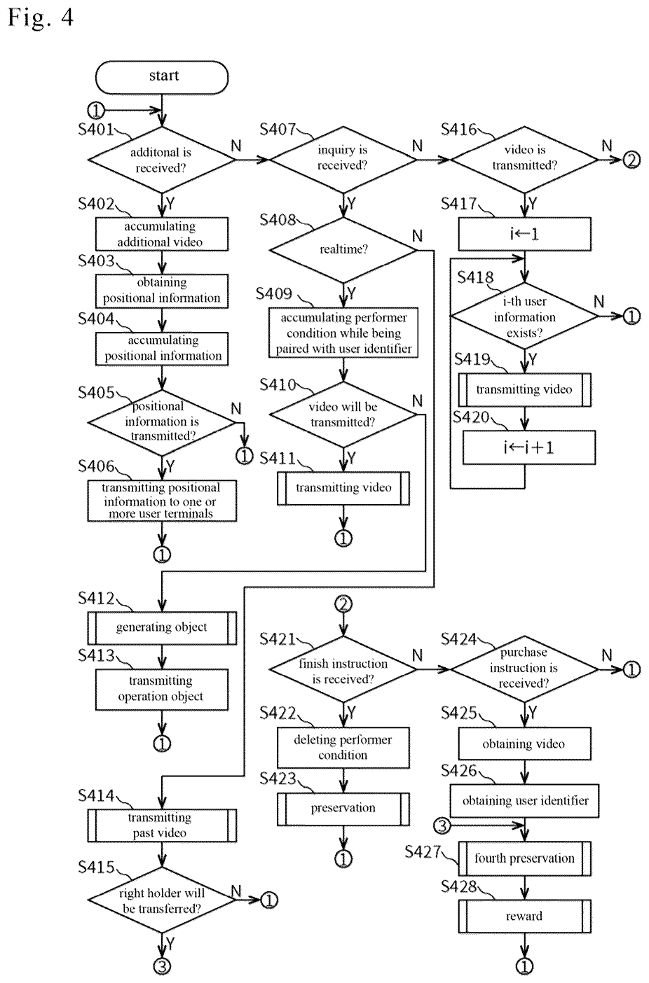

Then, the operation example of the information system A will be explained. First, the operation example of the information processing device 1 will be explained using the flowchart in FIG. 4. Note that “S” shown in each flowchart used in the following explanation means the step.

(S401) The receiver 12 determines whether or not the additional video is received from the mobile terminal 2. When the additional video is received, the processing proceeds to S402. When the additional video is not received, the processing proceeds to S407. Note that the received additional video is associated with the performer identifier.

(S402) The processor 13 accumulates the additional video received in S401 while being associated with the performer identifier.

(S403) The processor 13 obtains the positional information included in the additional video.

(S404) The processor 13 accumulates the positional information obtained in S403 while being paired with the performer identifier which is paired with the additional video. Note that the destination for accumulating the positional information is, for example, the storage 11. However, the destination is not limited.

(S405) The processor 13 determines whether or not the positional information accumulated in S404 is transmitted to one or more user terminals 3. When the positional information will be transmitted, the processing proceeds to S406. When the positional information will not be transmitted, the processing returns to S401.

The positional information is transmitted, for example, when the user information is managed in the user manager 112. The positional information is transmitted for informing the latest positional information of the performer to the user terminal 3.

(S406) The transmitter 14 transmits the positional information accumulated in S404 to one or more user terminals 3 while being paired with the performer identifier. The processing returns to S401.

Note that the one or more user terminals 3 to which the positional information is transmitted are the user terminal 3 associated with the user information managed in the user manager 112.

(S407) The inquiry receiver 123 determines whether or not the inquiry is received from the user terminal 3. When the inquiry is received, the processing proceeds to S408. When the inquiry is not received, the processing proceeds to S416. Note that the inquiry is normally associated with the user identifier of the user transmitting the inquiry. The inquiry here may be an expression of intention for setting the performer condition. When the inquiry is the expression of intention for setting the performer condition, the performer condition may not be accumulated in S409.

(S408) The processor 13 determines whether the inquiry received in S407 is the

instruction for transmitting the realtime video or the instruction for transmitting the past video. When the inquiry is the instruction for transmitting the realtime video, the processing proceeds to S409. When the inquiry is the instruction for transmitting the past video, the processing proceeds to S414.

For example, the processor 13 here determines whether the flag included in the inquiry is the flag for obtaining the realtime video or the flag for obtaining the past video.

(S409) The processor 13 accumulates the performer condition included in the received inquiry in the user manager 112 while being paired with the user identifier.

(S410) The processor 13 determines whether or not to transmit the video to the user terminal 3 which transmitted the inquiry. When the video will be transmitted, the processing proceeds to S411. When the video will not be transmitted, the processing proceeds to S412.

The case for transmitting the video is normally during the performance. The case for transmitting the video is, for example, the case when the flag indicating that the performer is during the performance is included in the storage 11. Note that the flag is the information for using the determination.

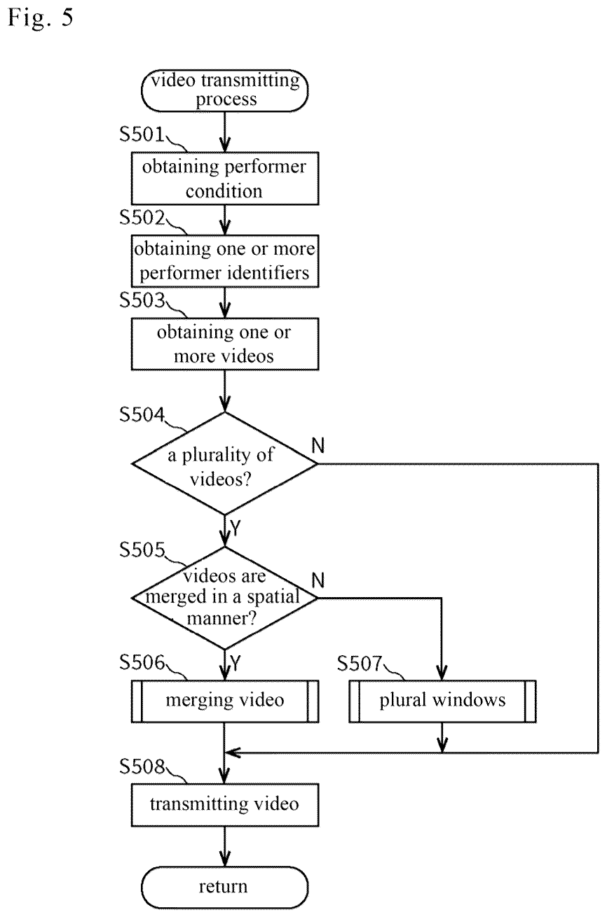

(S411) The video obtainer 133 or the like performs a video transmitting process to the user terminal 3 which transmitted the inquiry. The processing returns to S401. Note that the example of the video transmitting process will be explained using the flowchart in FIG. 5.

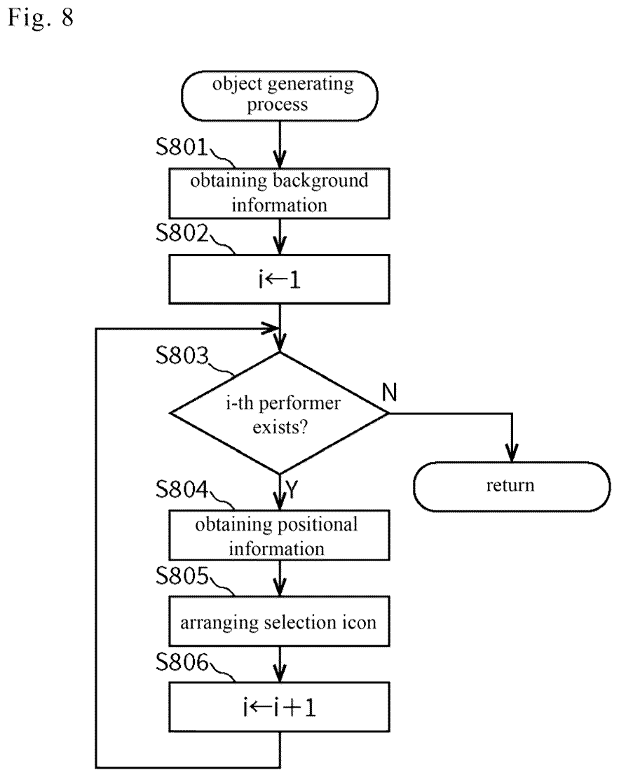

(S412) The object generator 132 performs an object generating process. The example of the object generating process will be explained using the flowchart in FIG. 8. Note that the object generating process is the process of generating the operation object used in the user terminal 3.

(S413) The object transmitter 141 transmits the operation object generated in S412 to the user terminal 3 which transmitted the inquiry. The processing returns to S401.

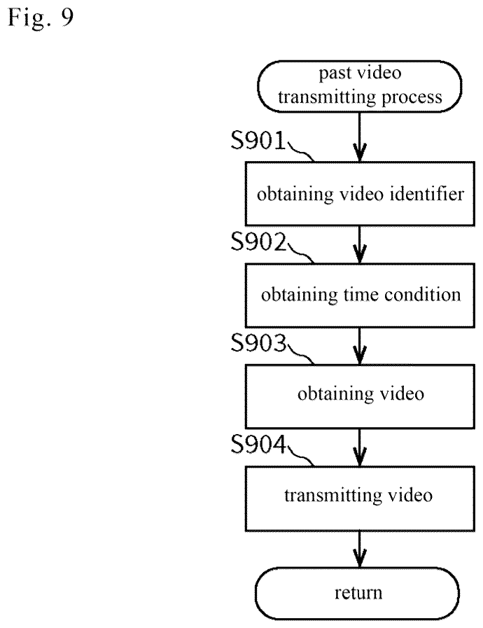

(S414) The processor 13 or the like performs a past video transmitting process. The example of the past video transmitting process will be explained using the flowchart in FIG. 9. Note that the past video transmitting process is the process of obtaining and transmitting the video accumulated in the past and the video satisfying the inquiry.

(S415) The processor 13 determines whether or not to transfer the right holder of the video obtained in S414. When the right holder will be transferred, the processing proceeds to S427. When the right holder will not be transferred, the processing returns to S401.

The case of transferring the right holder of the video is, for example, the case when the transfer flag of the right holder is included in the inquiry. However, the method of determining whether or not to transfer the right holder is not limited.

(S416) The processor 13 determines whether or not it is within the period of transmitting the video to one or more user terminals 3. When it is within the period of transmitting the video, the processing proceeds to S417. When it is not within the period of transmitting the video, the processing proceeds to S421. Note that the above described video is the realtime video.

For example, the processor 13 determines that it is within the period of transmitting the video when the terminal information exists in the terminal manager 111. For example, the processor 13 determines that it is within the period of transmitting the video when the flag indicating that the performance (e.g., soccer game) is currently performed is included in the storage 11. The method of determining that it is within the period of transmitting the video by the processor 13 is not limited.

(S417) The processor 13 substitutes 1 for a counter i.

(S418) The processor 13 determines whether or not the i-th user information exists in the user manager 112. When the i-th user information exists, the processing proceeds to S419. When the i-th user information does not exist, the processing proceeds to S401.

(S419) The video obtainer 133 or the like performs the video transmitting process to the user terminal 3 corresponding to the i-th user information. Note that the example of the video transmitting process will be explained using the flowchart in FIG. 5.

(S420) The processor 13 increments the counter i by 1. The processing returns to S418.

(S421) The receiver 12 determines whether or not the finish instruction is received from the user terminal 3. When the finish instruction is received, the processing proceeds to S422. When the finish instruction is not received, the processing proceeds to S424. Note that the finish instruction is associated with the user identifier.

(S422) The processor 13 deletes the performer condition paired with the user identifier corresponding to the finish instruction received in S421 from the user manager 112. Note that the processor 13 here may delete the user information associated with the user identifier corresponding to the finish instruction received in S421 from the user manager 112. When the above described performer condition or the user information including the performer condition is deleted, the video will not be transmitted to the user terminal 3 of the corresponding user any more.

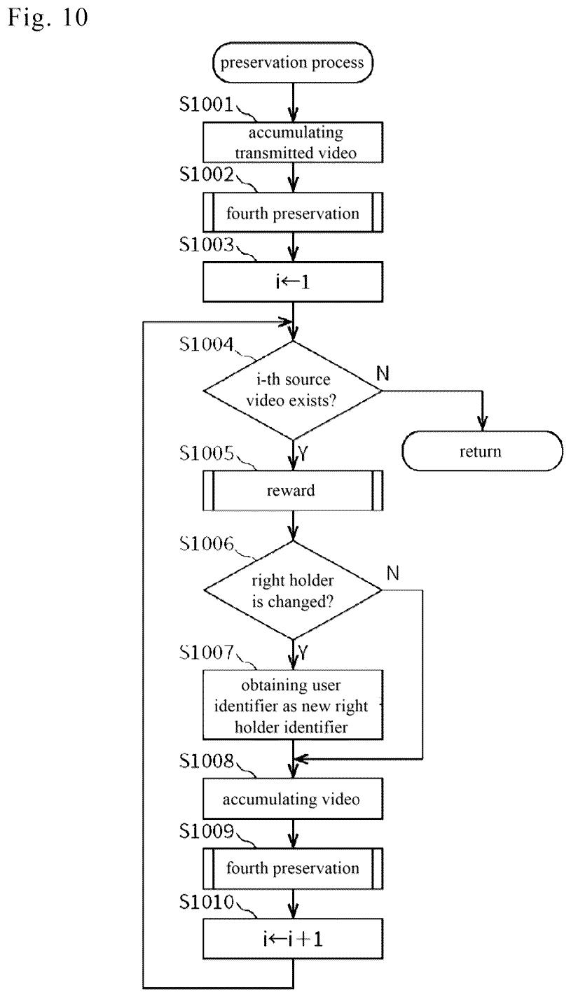

(S423) The right holder processor 135 performs a preservation process. The example of the preservation process will be explained using the flowchart in FIG. 10. Note that the target video of the preservation process is the video transmitted to the user terminal 3 corresponding to the finish instruction received in S421.

(S424) The receiver 12 determines whether or not the purchase instruction is received from the user terminal 3. When the purchase instruction is received, the processing proceeds to S425. When the purchase instruction is not received, the processing returns to S401.

(S425) The video obtainer 133 obtains the video corresponding to the purchase instruction. For example, the video obtainer 133 obtains the video corresponding to the purchase instruction from the videos accumulated in the right holder processor 135.

(S426) The fourth preserver 1354 obtains the user identifier corresponding to the user terminal 3 transmitted the purchase instruction. Note that the user identifier functions as the right holder identifier corresponding to the purchased video. The user terminal 3 transmitted the purchase instruction may be the user terminal 3 transmitted the inquiry including the transfer flag of the right holder.

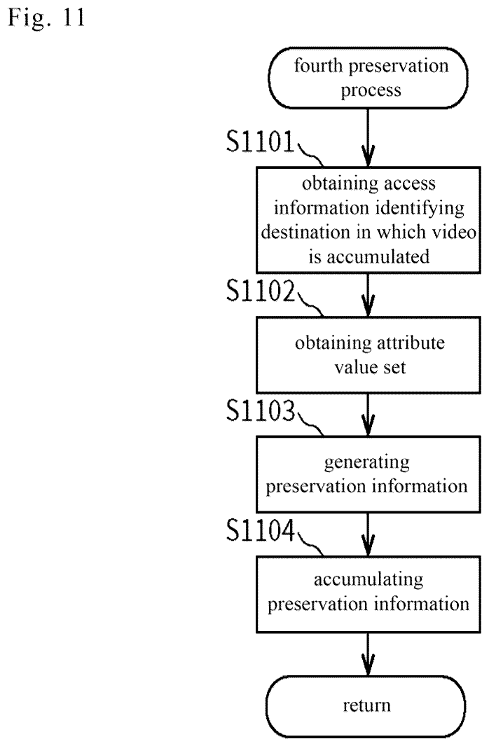

(S427) The fourth preserver 1354 performs the fourth preservation process using the user identifier obtained in S427. The example of the fourth preservation process will be explained using the flowchart in FIG. 11.

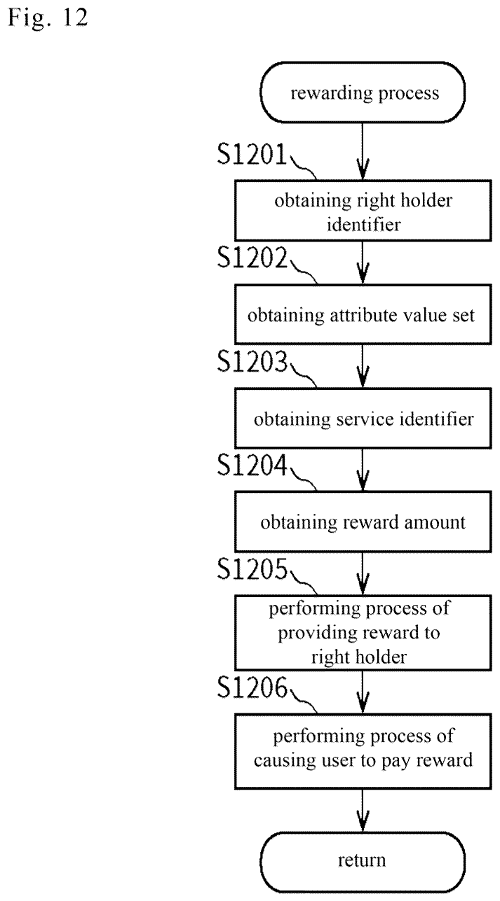

(S428) The rewarding unit 1355 performs the rewarding process to the original right holder of the video to be purchased. The processing returns to S401. The example of the rewarding process will be explained using the flowchart in FIG. 12.

In the flowchart in FIG. 4, the process ends when the power is turned off or the instruction of ending process is interrupted.

Then, the example of the video transmitting process in S411 will be explained using the flowchart in FIG. 5.

(S501) The video obtainer 133 obtains the performer condition paired with the user identifier of the user terminal 3 transmitting the video from the user manager 112.

(S502) The video obtainer 133 obtains one or more performer identifiers satisfying the performer condition obtained in S501.

(S503) The video obtainer 133 obtains the video which is accumulated in S402 and is paired with each of one or more performer identifiers obtained in S502. Note that the length of the video obtained by the video obtainer 133 is not limited. The video obtained by the video obtainer 133 is the stored video and is preferably all videos which have not yet transferred. The obtained video is preferably the additional video. However, the obtained video may be only the video.

(S504) The video generator 134 determines whether or not a plurality of videos is included in the video obtained in S503. When a plurality of videos is included, the processing proceeds to S505. When only one video is included, the processing proceeds to S508.

(S505) The video generator 134 determines whether or not to merge a plurality of videos obtained in S503 in a spatial manner. When the plurality of videos will be merged, the processing proceeds to S506. When the plurality of videos will not be merged, the processing proceeds to S507.

Note that the video generator 134 determines to merge a plurality of videos in a spatial manner when a spatial overlap is included in a plurality of videos. For example, the video generator 134 recognizes the first frame of each of a plurality of videos and determines to merge the frames in a spatial manner when all frames are determined to be overlapped with the other one or more frames. For example, the video generator 134 determines to merge the frames in a spatial manner when all positional information corresponding to each of a plurality of videos obtained in S503 are within the threshold value. Note that the method of determining to merge the video by the video generator 134 is not limited.

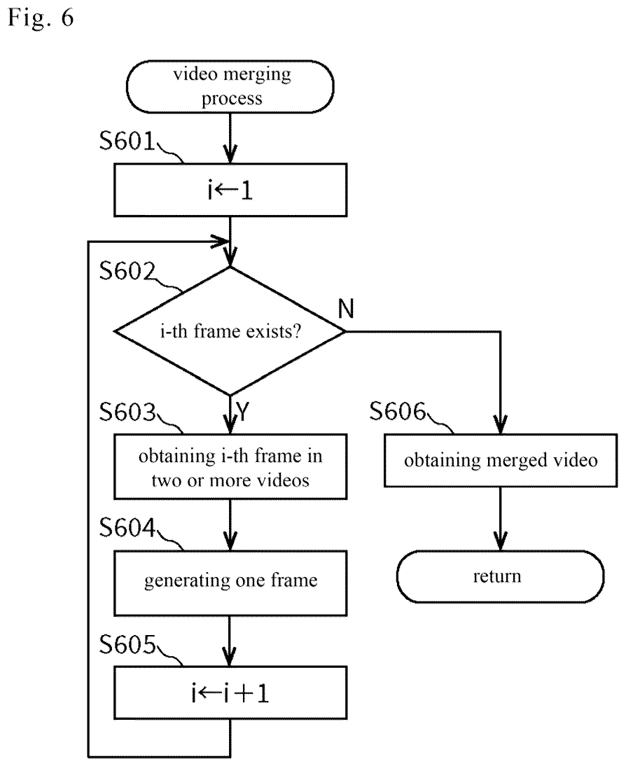

(S506) The video generator 134 performs a video merging process which is a process of merging a plurality of videos obtained in S503 in a spatial manner. Then, the example of the video merging process will be explained using the flowchart in FIG. 6.

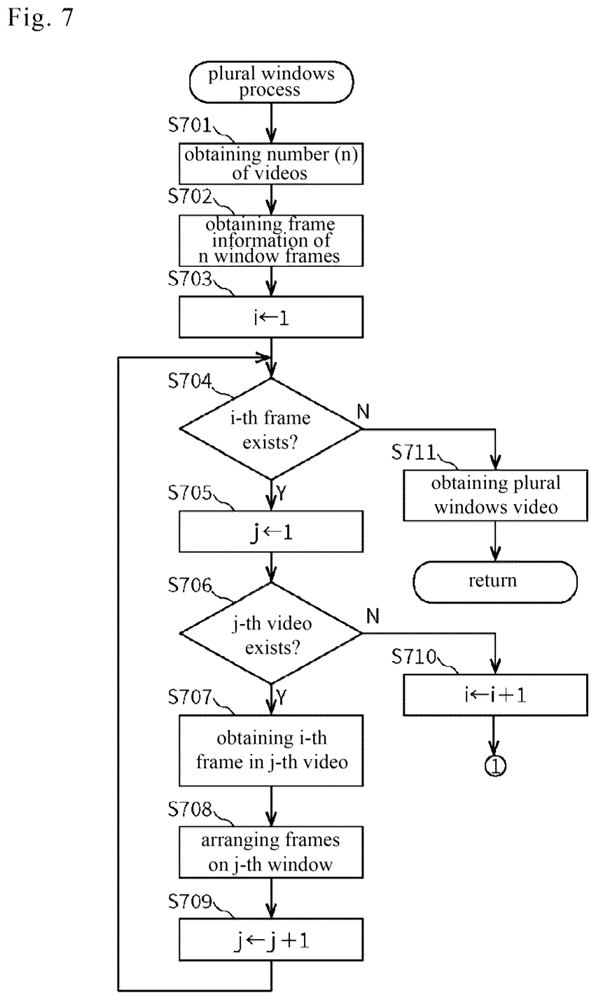

(S507) The video generator 134 performs a plural windows process. The plural windows process is the process of arranging each of a plurality of videos obtained in S503 on the windows different from each other. The example of the plural windows process will be explained using the flowchart in FIG. 7.

(S508) The video transmitter 142 transmits one video obtained in S503, the merged video obtained in S506, or a plurality of windows obtained in S507 to the user identifier. The processing returns to the upstream process.

Then, the example of the video merging process in S506 will be explained using the flowchart in FIG. 6.

(S601) The video generator 134 substitutes 1 for the counter i.

(S602) The video generator 134 determines whether or not the i-th frame exists in each of a plurality of obtained videos. When the i-th frame exists, the processing proceeds to S603.

When the i-th frame does not exist, the processing proceeds to S606.

(S603) The video generator 134 obtains the i-th frame in each of a plurality of obtained videos.

(S604) The video generator 134 obtains one frame by merging a plurality of frames obtained in S603. Note that the example of the technology for generating one frame by merging a plurality of frames in a spatial manner is described above.

(S605) The video generator 134 increments the counter i by 1. The processing returns to S602.

(S606) The video generator 134 combines a plurality of frames obtained in S604 in the order of obtaining the frames to obtain the merged video. The processing returns to the upstream process.

Note that it is assumed that a plurality of the obtained videos is synchronized in time with each other in the flowchart in FIG. 6.

Then, the example of the plural windows process in S507 will be explained using the flowchart in FIG. 7.

(S701) The video generator 134 obtains the number (n) of the obtained videos.

(S702) The video generator 134 obtains a frame information including n window frames. Note that the frame information is the information of the background which forms the frame.

(S703) The video generator 134 substitutes 1 for the counter i.

(S704) The video generator 134 determines whether or not the i-th frame exists of each of a plurality of videos. When the i-th frame exists, the processing proceeds to S705. When the i-th frame does not exist, the processing proceeds to S711.

(S705) The video generator 134 substitutes 1 for a counter j.

(S706) The video generator 134 determines whether or not the j-th video exists in the obtained video. When the j-th video exists, the processing proceeds to S707. When the j-th video does not exist, the processing proceeds to S710.

(S707) The video generator 134 obtains the i-th frame in the j-th video.

(S708) The video generator 134 arranges the frames obtained in S707 on the j-th window in the frame information.

(S709) The video generator 134 increments the counter j by 1. The processing returns to S706.

(S710) The video generator 134 increments the counter i by 1. The processing returns to S704.

(S711) The video generator 134 combines a plurality of frames obtained in S708 in a time series manner in the order of obtaining the frames to generate the video. The processing returns to the upstream process. Note that the above described video is the plural windows video.

Note that it is assumed that a plurality of obtained videos is synchronized in time with each other in the flowchart in FIG. 7.

Then, the example of the object generating process in S412 will be explained using the flowchart in FIG. 8.

(S801) The object generator 132 obtains the background information from the storage 11.

(S802) The object generator 132 substitutes 1 for the counter i.

(S803) The object generator 132 determines whether or not the i-th performer exists. When the i-th performer exists, the processing proceeds to S804. When the i-th performer does not exist, the processing returns to the upstream process. Note that the i-th performer is normally the performer during the performance (e.g., participating in a game).

For example, the object generator 132 determines whether or not the i-th performer exists by determining whether or not the i-th terminal information exists in the terminal manager 111. For example, the object generator 132 refers to the terminal manager 111 and determines whether or not the i-th performer whose performance flag is ON (e.g., “1”) exists. The performance flag is the information J indicating the fact that the performance is now performed or not. Note that the method of determining whether or not the i-th performer exists is not limited.

(S804) The object generator 132 obtains the latest positional information of the i-th performer from the terminal manager 111.

(S805) The object generator 132 arranges a selection icon, which is the icon for selecting the i-th performer, on the position indicated by the positional information obtained in S804 and the position in the background image generated by the background information. Note that the selection icon is the object which can be selected. The selection icon is, for example, a symbol. However, the selection icon may be a string. The selection icon is, for example, stored in the storage 11.

(S806) The object generator 132 increments the counter i by 1. In the flowchart in FIG. 8, a user interface simulating a performance field on which selectable icons are arranged is generated on the current position of the performer by the process of S805. The above described user interface is the operation object.

Then, the example of the past video transmitting process in S414 will be explained using the flowchart in FIG. 9.

(S901) The video obtainer 133 obtains a video identifier satisfying the inquiry where the video identifier is stored in the past. The video identifier is the information for identifying the video. The video identifier is, for example, an identification (ID) or a video name. However, the video identifier is not limited.

(S902) The video obtainer 133 obtains the time condition included in the inquiry.

(S903) The video obtainer 133 obtains the video stored by the right holder processor 135 in the past in the videos identified by the video identifier within the range satisfying the time condition.

(S904) The video transmitter 142 transmits the video obtained in S903 to the user terminal 3 from which the inquiry is transmitted. The processing returns to the upstream process.

Then, the example of the preservation process in S423 will be explained using the flowchart in FIG. 10.

(S1001) The right holder processor 135 accumulates the transmitted video while being associated with the attribute value set which is associated with each of one or a plurality of videos which are the source of the transmitted video.

Note that the right holder processor 135 preferably accumulates the above described video while being associated with the right holder identifier for identifying each of one or a plurality of right holders. The right holder identifier here is, for example, one or more performer identifiers of the video which is the source of the accumulated video. The right holder identifier here is, for example, one user identifier for identifying the user transmitting the inquiry.

For example, the right holder processor 135 accumulates the video in the storage 11 or another devise than the information processing device 1. Another device than the information processing device 1 may be a device included in a blockchain.

(S1002) The fourth preserver 1354 performs the fourth preservation process. The example of the fourth preservation process is explained using the flowchart in FIG. 11. (S1003) The right holder processor 135 substitutes 1 for the counter i.

(S1004) The right holder processor 135 determines whether or not the i-th video which is the source of the accumulated video exists. When the i-th video exists, the processing proceeds to S1005. When the i-th video does not exist, the processing returns to the upstream process.

(S1005) The rewarding unit 1355 performs the rewarding process. The example of the rewarding process will be explained using the flowchart in FIG. 12. The rewarding process here is the rewarding process to the right holder of the i-th video which is the source of the accumulated video.

(S1006) The right holder processor 135 determines whether or not to change the right holder of the i-th video which is the source of the accumulated video. When the right holder will be changed, the processing proceeds to S1007. When the right holder will not be changed, the processing proceeds to S1008.

Whether or not to change the right holder may be determined based on the flag associated with the i-th video, may be preliminarily determined, or may be changed when “the information indicating the change request of the right holder” is included in the inquiry.

(S1007) The right holder processor 135 obtains the user identifier of the user terminal 3. Note that the above described user identifier becomes a new right holder identifier.

(S1008) The first preserver 1351 accumulates the i-th video which is the source of the accumulated video.

(S1009) The fourth preserver 1354 performs the fourth preservation process related to the i-th video which is the source of the accumulated video. The example of the fourth preservation process is explained using the flowchart in FIG. 11.

(S1010) The right holder processor 135 increments the counter i by 1. The processing returns to S1004.

In the flowchart in FIG. 10, the process (S1008) of accumulating a plurality of videos which is the source of the combined video and the fourth preservation process (S1009) are performed when the combined video is generated. However, the above described processes can be omitted.

Then, the example of the fourth preservation process in S427, S1002 and S1009 will be explained using the flowchart in FIG. 11.

(S1101) The fourth preserver 1354 obtains the access information for identifying the destination for accumulating the video. Note that the above described video is, for example, the merged video or the combined video. The access information is, for example, URL.

(S1102) The fourth preserver 1354 obtains the attribute value set corresponding to the accumulated video. When the accumulated video is the video generated from a plurality of source videos, the attribute value set corresponding to the video is the attribute value set of each video which is a plurality of source videos.

(S1103) The fourth preserver 1354 generates the preservation information including the access information obtained in S1101, the attribute value set obtained in S1102 and the right holder identifier of the video. When new right holder identifier is obtained, the fourth preserver 1354 generates, for example, the preservation information including the new right holder identifier and the original right holder identifier.

(S1104) The fourth preserver 1354 accumulates the preservation information generated in S1103. The processing returns to the upstream process.

When the preservation information of the video corresponding to the preservation information to be accumulated is accumulated in S1104, the preservation information is overwritten on the preservation information generated in S1103. By the above described operation, the transition of the right holder of the video can be managed. The fourth preserver 1354 accumulates the preservation information in a blockchain, for example.

Then, the example of the rewarding process in S428 and S1005 will be explained using the flowchart in FIG. 12.

(S1201) The rewarding unit 1355 obtains one or a plurality of right holder identifiers of the target video. The rewarding unit 1355 may obtain the right holder identifier of the past right holder of the target video.

(S1202) The rewarding unit 1355 obtains the attribute value set of the target video.

(S1203) The rewarding unit 1355 obtains the service identifier for identifying the service performed on the target video. The service identifier is, for example, “viewing” and “purchasing.”

(S1204) The rewarding unit 1355 obtains the reward amount using the attribute value set obtained in S1202 and one or a plurality of information of the service identifier obtained in S1203.

When a plurality of right holder identifiers is obtained, the rewarding unit 1355 obtains the reward amount to each of the right holder identifiers. When the history information of the right holder including a plurality of right holder identifiers is obtained, the rewarding unit 1355 may obtain the reward amount to each of the right holder identifiers.

For example, the rewarding unit 1355 preferably obtains the video attribute value corresponding to each of a plurality of videos which is the source of the video and transmitted by the video transmitter 142 and determines the reward amount of each of a plurality of right holders using the video attribute value. For example, the rewarding unit 1355 preferably determines the reward amount so that the reward amount increases as the data amount, the time of the video or the number of the frames of the original video adopted in the video transmitted by the video transmitter 142 increases. For example, the rewarding unit 1355 preferably determines the reward amount so that the reward amount increases as the resolution of the original video adopted in the video transmitted by the video transmitter 142 increases.

(S1205) The rewarding unit 1355 performs the process of providing the reward to the right holder identified by the right holder identifier obtained in S1201 by the reward amount obtained in S1204.

(S1206) The rewarding unit 1355 performs the process of causing the user that has enjoyed the service relevant to the target video to pay the reward. The processing returns to the upstream process. Note that the target video is normally the video transmitted to the user terminal 3.

In the flowchart in FIG. 12, it is possible to obtain and accumulate the profit obtained by the management side of the information processing device 1.

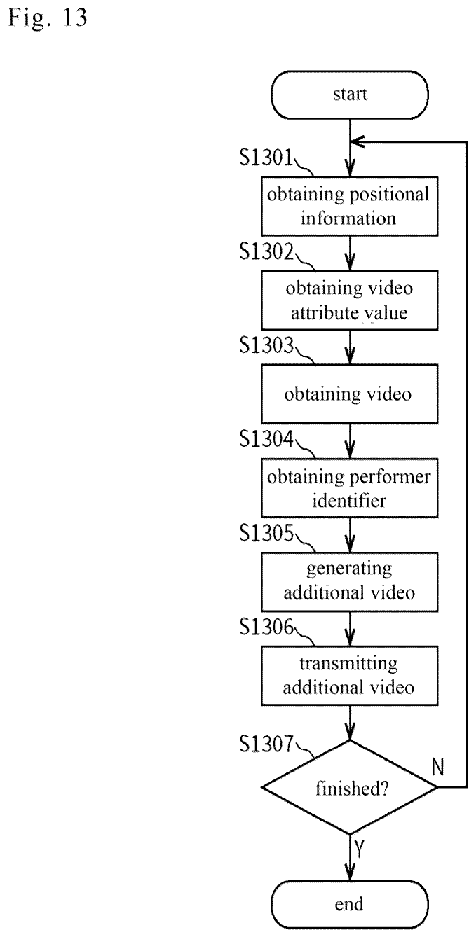

Then, the operation example of the mobile terminal 2 will be explained using the flowchart in FIG. 13.

(S1301) The position obtainer 231 obtains the positional information. Note that the positional information is also the video attribute value.

(S1302) The attribute value obtainer 233 obtains one or more video attribute values. Note that the one or more video attribute values include, for example, the time information.

(S1303) The image capturer 232 obtains the video. Note that the time of obtaining the video is not limited here.

(S1304) The mobile processor 23 obtains the performer identifier from the mobile storage 21.

(S1305) The mobile processor 23 generates the additional video including the video, the positional information, one or more video attribute values and the performer identifier.

(S1306) The mobile video transmitter 242 transmits the additional video generated in S1305 to the information processing device 1.

(S1307) The mobile processor 23 determines whether or not to finish the process. When the process will be finished, the process is finished. When the process will not be finished, the processing returns to S1301.

Note that the case when the process will be finished is, for example, when the end instruction is received from the performer or when a predetermined time or more is passed from the start of the process.

In the flowchart in FIG. 13, the mobile terminal 2 may continuously obtain the positional information and transmit the positional information to the information processing device 1 while being paired with the performer identifier. In the above described case, the mobile terminal 2 may transmit the video to the information processing device 1 when the transmission instruction of the video is received from the information processing device 1.

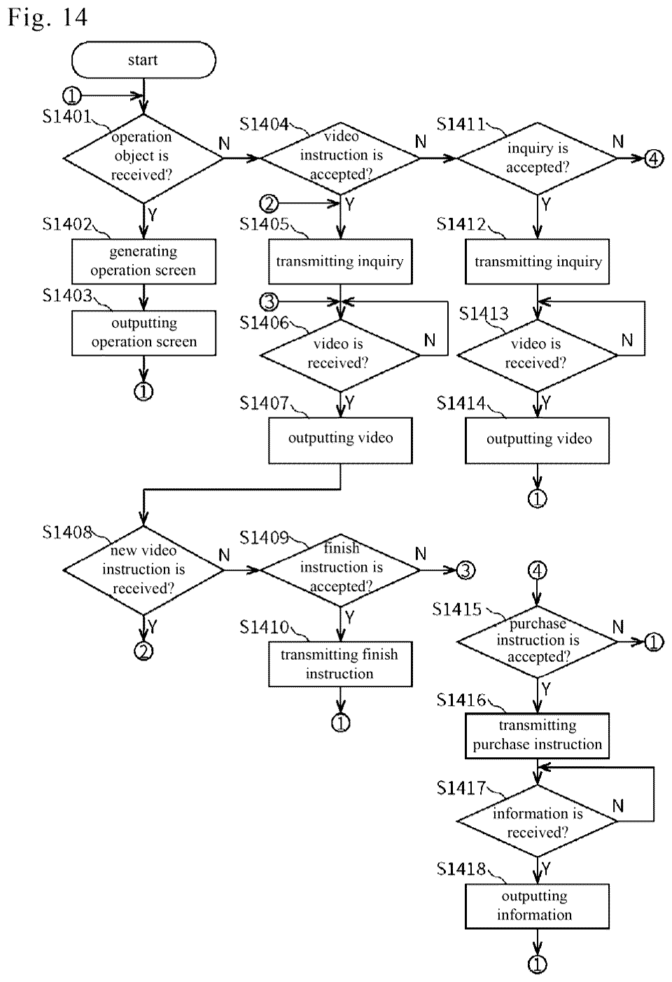

Then, the operation example of the user terminal 3 will be explained using the flowchart in FIG. 14.

(S1401) The user receiver 35 determines whether or not the operation object is received from the information processing device 1. When the operation object is received, the processing proceeds to S1402. When the operation object is not received, the processing proceeds to S1404.

(S1402) The screen obtainer 331 generates the operation screen using the operation object received in S1401.

(S1403) The screen output unit 361 outputs the operation screen generated in S1402. The processing returns to S1401.

(S1404) The user acceptor 32 determines whether or not the video instruction is accepted. When the video instruction is accepted, the processing proceeds to S1405. When the video instruction is not accepted, the processing proceeds to S1411.

(S1405) The user processor 33 obtains the performer condition corresponding to the accepted video instruction. Then, the user processor 33 generates the inquiry including the performer condition and the user identifier. Then, the user transmitter 34 transmits the inquiry to the information processing device 1.

(S1406) The user receiver 35 determines whether or not the video is received from the information processing device 1. When the video is received, the processing proceeds to S1407. When the video is not received, the processing returns to S1406. Note that the video here may be, for example, the additional video.

(S1407) The video output unit 251 outputs the video received in S1406.

(S1408) The user acceptor 32 determines whether or not a new video instruction is received. When a new video instruction is received, the processing proceeds to S1405. When a new video instruction is not received, the processing proceeds to S1409.

(S1409) The user acceptor 32 determines whether or not the finish instruction is accepted. When the finish instruction is accepted, the processing proceeds to S1410. When the finish instruction is not accepted, the processing returns to S1406.

(S1410) The user processor 33 obtains the user identifier from the user storage 31. Then, the user processor 33 generates the finish instruction including the user identifier. The user transmitter 34 transmits the finish instruction to the information processing device 1. The processing returns to S1401.

(S1411) The user acceptor 32 determines whether or not the inquiry is accepted. When the inquiry is accepted, the processing proceeds to S1412. When the inquiry is not accepted, the processing proceeds to S1415.

(S1412) The user processor 33 obtains the user identifier from the user storage 31. Then, the user processor 33 generates the inquiry including the user identifier. The user transmitter 34 transmits the inquiry to the information processing device 1.

(S1413) The user receiver 35 determines whether or not the video is received from the information processing device 1 when the inquiry is transmitted. When the video is received, the processing proceeds to S1414. When the video is not received, the processing returns to S1413.

(S1414) The user output unit 36 outputs the video received in S1413. The processing returns to S1401.

(S1415) The user acceptor 32 determines whether or not the purchase instruction is accepted. When the purchase instruction is accepted, the processing proceeds to S1165. When the purchase instruction is not accepted, the processing returns to S1401. Note that the purchase instruction includes, for example, the inquiry for identifying the video to be purchased.

(S1416) The user processor 33 generates the purchase instruction to be transmitted. Then, the user transmitter 34 transmits the purchase instruction to the information processing device 1 while being associated with the user identifier.

(S1417) The user receiver 35 determines whether or not the information is received from the information processing device 1. When the information is received, the processing proceeds to S1120. When the information is not received, the processing returns to S1119. Note that the information is, for example, the video, the information indicating the fact that the transfer of the right holder is finished and the attribute value set of the video.

(S1418) The user processor 33 generates the information to be transmitted using the received information. The user output unit 36 outputs the above described information. The processing returns to S1101.

In the flowchart in FIG. 14, the process ends when the power is turned off or the instruction of ending process is interrupted.

Hereafter, specific examples of the operation of the information system A in the present embodiment will be explained.

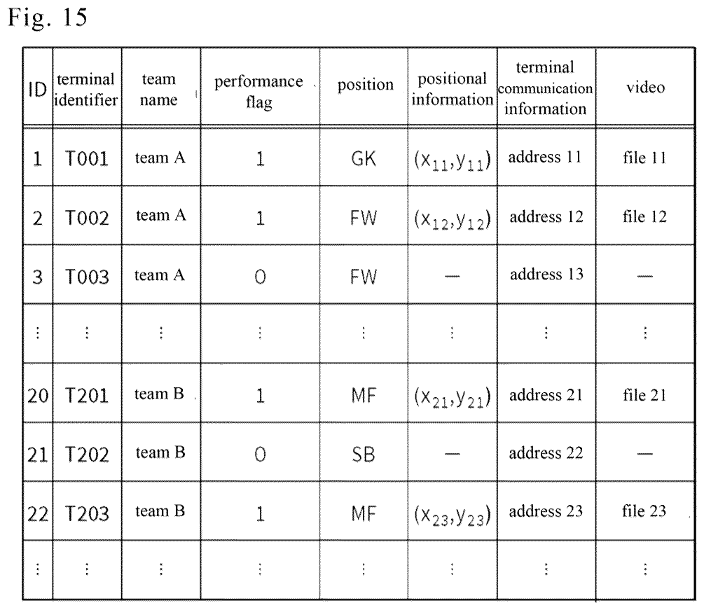

It is assumed that a terminal management table having the structure shown in FIG. 15 is stored in the terminal manager 111 of the information processing device 1. The terminal management table is the table for managing the mobile terminal 2. It is assumed that the mobile terminal 2 here is the terminal installed on a uniform of a player playing soccer game.

The terminal management table manages the record including “ID,” “terminal identifier,” “team name,” “performer flag,” “position,” “positional information,” “terminal communication information” and “video.” The “ID” is the information for identifying the record. The “team name” is the identifier of the team to which the performer (here, player) belongs. The “performer flag” is the information indicating whether or not the performer participates in a soccer game. “1” indicates that the performer participates in the game, while “0” indicates that the performer does not participate in the game. The “position” is the position of the player. The “positional information” is the latest positional information of the player. Note that all of the received positional information may be stored in the “positional information.” The “terminal communication information” is the information for communicating with the mobile terminal 2. The “video” is the name of the video file transmitted from the mobile terminal 2 of the player. Note that it is assumed that the video file is temporarily stored in the storage 11.

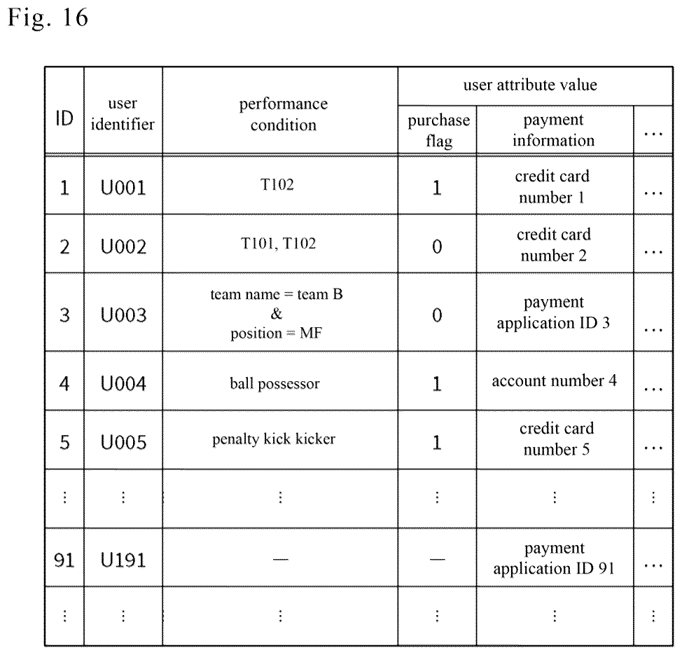

It is assumed that the user manager 112 stores a user management table having the structure shown in FIG. 16. The user management table manages the record having “ID,” “user identifier,” “performer condition” and “user attribute value.” The “user attribute value” includes “purchase flag” and “payment information.” The “purchase flag” is the information indicating whether or not the video is purchased. “1” indicates that the video is purchased, while “0” indicates that the video is not purchased. The “payment information” is the information for paying the fee for purchasing or viewing the video. The “payment information” here is a credit card number, an account information of the bank, or a user ID of the payment application. The “payment information” is, for example, the information registered when a ticket of the soccer game is purchased by the user.

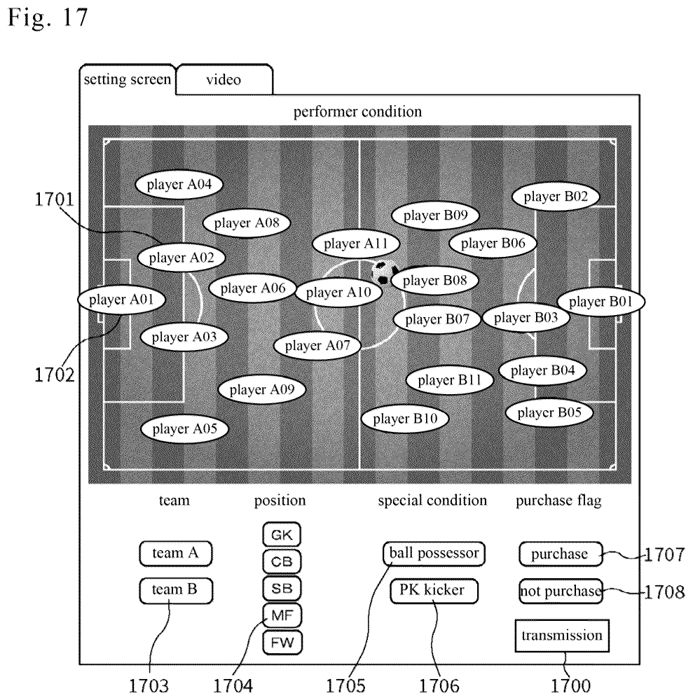

It is assumed that a large number of supporters (users) currently set the performer condition using a performer condition setting screen (also referred to as an operation screen) shown in FIG. 17 displayed on the user terminal 3 before the soccer game, for example. Note that the following processes are performed for outputting the operation screen on the user terminal 3. Namely, the user receiver 35 of the user terminal 3 receives the operation object from the information processing device 1. Then, the screen obtainer 331 generates the operation screen using the operation object. Then, the screen output unit 361 outputs the above described operation screen (FIG. 17).

The operation screen (FIG. 17) includes various kinds of buttons (e.g., 1701 to 1706) for setting the performer condition, a transmitting button 1700, a “purchase” button 1707 and a “not purchase” button 1708 which are the purchase flag. When the “purchase” button 1707 is instructed, the purchase flag to be transmitted is “1.” When the “not purchase” button 1708 is instructed, the purchase flag to be transmitted is “0.”

It is assumed that the user 1 identified by the user identifier “U101” instructs the icon of the player A02 in 1701 of FIG. 17 and the “purchase” button 1707 and then instructs the “transmission” button 1700. Thus, the user acceptor 32 accepts the video instruction “<performer condition> T102 <purchase flag> 1.” Then, the user processor 33 generates the inquiry “<user identifier> U101 <performer condition> T102 <purchase flag> 1 <video type> realtime” corresponding to the above described video instruction. The user transmitter 34 transmits the above described inquiry to the information processing device 1.

Then, the inquiry receiver 123 of the information processing device 1 receives the inquiry from the user terminal 3. Then, the processor 13 determines that the transmission of the realtime video is instructed from “<video type> realtime” included in the received inquiry. Then, the processor 13 accumulates the performer condition “T102” and the purchasing flag “1” included in the received inquiry in the user management table (FIG. 16) while being paired with the user identifier “U101” included in the inquiry. The above described record is the record of “ID=1” in FIG. 16.

It is assumed that the user 1 identified by the user identifier “U102” instructs two icons of players A01 and A02 in 1701 of FIG. 17 and the “not purchase” button 1708 and then instructs the “transmission” button 1700. Thus, the user acceptor 32 accepts the video instruction “<performer condition> T101, T102 <purchase flag> 0.” Then, the user processor 33 generates the inquiry “<user identifier> U102 <performer condition> T101, T102 <purchase flag> 0 <video type> realtime” corresponding to the above described video instruction. The user transmitter 34 transmits the above described inquiry to the information processing device 1.

Then, the inquiry receiver 123 of the information processing device 1 receives the inquiry from the user terminal 3. Then, the processor 13 determines that the transmission of the realtime video is instructed from “<video type> realtime” included in the received inquiry. Then, the processor 13 accumulates the performer condition “T101, T102” and the purchase flag “0” included in the received inquiry in the user management table (FIG. 16) while being paired with the user identifier “U102” included in the inquiry. The above described record is the record of “ID=2” in FIG. 16.

It is assumed that the user 1 identified by the user identifier “U103” instructs the “team B” 1703, the position “MF” 1704 and “not purchase” button 1708 in FIG. 17, and then instructs “transmission” button 1700. Thus, the user acceptor 32 accepts the video instruction “<performer condition> team name=team B & position=MF <purchase flag> 0.” Then, the user processor 33 generates the inquiry “<user identifier> U103 <performer condition> team name=team B & position=MF <purchase flag> 0 <video type> realtime” corresponding to the above described video instruction. The user transmitter 34 transmits the above described inquiry to the information processing device 1.

Then, the inquiry receiver 123 of the information processing device 1 receives the inquiry from the user terminal 3. Then, the processor 13 determines that the transmission of the realtime video is instructed from “<video type> realtime” included in the received inquiry. Then, the processor 13 accumulates the performer condition “team name=team B & position=MF” and the purchase flag “0” included in the received inquiry in the user management table (FIG. 16) while being paired with the user identifier “U103” included in the inquiry. The above described record is the record of “ID=3” in FIG. 16.

It is assumed that the user 1 identified by the user identifier “U104” instructs the “ball possessor” 1703 and the “purchase” button 1707 in FIG. 17, and then instructs “transmission” button 1700. Thus, the user acceptor 32 accepts the video instruction “<performer condition> ball possessor <purchase flag> 1.” Then, the user processor 33 generates the inquiry “<user identifier> U104 <performer condition> ball possessor <purchase flag> 1 <video type> realtime” corresponding to the above described video instruction. The user transmitter 34 transmits the above described inquiry to the information processing device 1.

Then, the inquiry receiver 123 of the information processing device 1 receives the inquiry from the user terminal 3. Then, the processor 13 determines that the transmission of the realtime video is instructed from “<video type> realtime” included in the received inquiry. Then, the processor 13 accumulates the performer condition “ball possessor” and the purchasing flag “1” included in the received inquiry in the user management table (FIG. 16) while being paired with the user identifier included in the inquiry. The above described record is the record of “ID=4” in FIG. 16.

It is assumed that the user 1 identified by the user identifier “U105” instructs the “penalty kick kicker” 1706 and the “purchase” button 1707 in FIG. 17, and then instructs “transmission” button 1700. Thus, the user acceptor 32 accepts the video instruction “<performer condition> penalty kick kicker <purchase flag> 1.” Then, the user processor 33 generates the inquiry “<user identifier> U105 <performer condition> penalty kick kicker <purchase flag> 1 <video type> realtime” corresponding to the above described video instruction. The user transmitter 34 transmits the above described inquiry to the information processing device 1.

Then, the inquiry receiver 123 of the information processing device 1 receives the inquiry from the user terminal 3. Then, the processor 13 determines that the transmission of the realtime video is instructed from “<video type> realtime” included in the received inquiry. Then, the processor 13 accumulates the performer condition “penalty kick kicker” and the purchasing flag “1” included in the received inquiry in the user management table (FIG. 16) while being paired with the user identifier “U105” included in the inquiry. The above described record is the record of “ID=5” in FIG. 16.

It is assumed that the soccer game is started in the above described situation. It is assumed that the positional information identifying the position of the soccer ball is continuously transmitted from the device embedded in the soccer ball during the soccer game to the information processing device 1. It is assumed that the information processing device 1 receives the positional information of the soccer ball and accumulates the positional information in the storage 11. It is assumed that the storage 11 stores the PK positional information for identifying the position of kicking the PK (penalty kick).

It is assumed that the additional video is continuously transmitted from the mobile terminal 2 of 22 players participating in the soccer game to the information processing device 1 during the soccer game. It is assumed that the information processing device 1 receives the additional video and accumulates the video and the positional information in the storage 11 while being paired with the terminal identifier.

The processor 13 of the information processing device 1 determines that it is within the period of transmitting the video to one or more user terminals 3 during the soccer game. The information processing device 1 continues to transmit the video to the user terminal 3 which draws the video in accordance with the performer condition of each user.

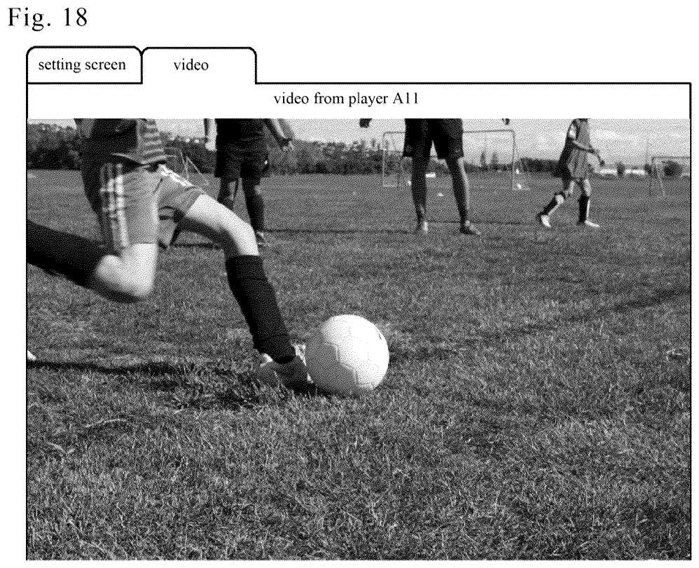

For example, the information processing device 1 continues to transmit the video corresponding to the terminal identifier “T102” to the user terminal 3 corresponding to the user identifier “U101.” The above described user terminal 3 receives and outputs the video. The image of the above described video is FIG. 18.

Note that the user identified by the user identifier “U101” can change the performer condition anytime during the game by operating the setting screen shown in FIG. 17. Namely, the user can set new performer condition anytime during the game by operating the setting screen shown in FIG. 17.

Since the purchase flag paired with the user identifier “U101” is “1,” the above described user will purchase the video viewed during the game. As a result, the information processing device 1 performs the above described fourth preservation process and the above described rewarding process on the video viewed by the user.

For example, the information processing device 1 continues to transmit one merged image formed by merging the videos transmitted from each of two mobile terminals 2 identified by the terminal identifiers “T201, T203” paired with “team name =team B” and “position=MF” in a spatial manner or a plurality of window videos to the user terminal 3 corresponding to the user identifier “U103.” The user terminal 3 receives and outputs the above described video.

Since the purchase flag paired with the user identifier “U103” is “0,” the fourth preservation process and the rewarding process are not performed on the video viewed by the above described user during the game.

For example, the video obtainer 133 of the information processing device 1 always obtains the video paired with the terminal identifier corresponding to the positional information associated with the nearest position to the positional information of the ball and obtains the combined video formed by combining the videos in a time series manner in the user terminal 3 associated with the user identifier “U104.” The video transmitter 142 continues to transmit the above described combined video. The user terminal 3 receives and transmits the video.

Since the purchase flag paired with the user identifier “U104” is “1,” the user will purchase the combined video viewed by the above described user during the game. As a result, the information processing device 1 performs the above described fourth preservation process and the above described rewarding process on the combined video viewed by the above described user.

As described above, in the present embodiment, the videos captured by the mobile terminal 2 of the performer can be utilized during the performance of the performer.

In the present embodiment, the video of an appropriate performer can be utilized.

In the present embodiment, one video can be generated from the videos of a plurality of performers.

In the present embodiment, the videos of an appropriate time of the performer can be utilized.

In the present embodiment, it is possible to support the user to select the video easily.

In the present embodiment, an appropriate process related to the right holder of the video can be performed.

In the present embodiment, the reward can be provided to the right holder of the video captured by the mobile terminal 2.

Various kinds of processes of various kinds of devices in the present embodiment may be implemented with software. The software may be distributed by, for example, downloading the software. The software may be recorded in a recording medium such as a compact disk read-only memory (CD-ROM) for distribution. The same applies to another embodiment herein.

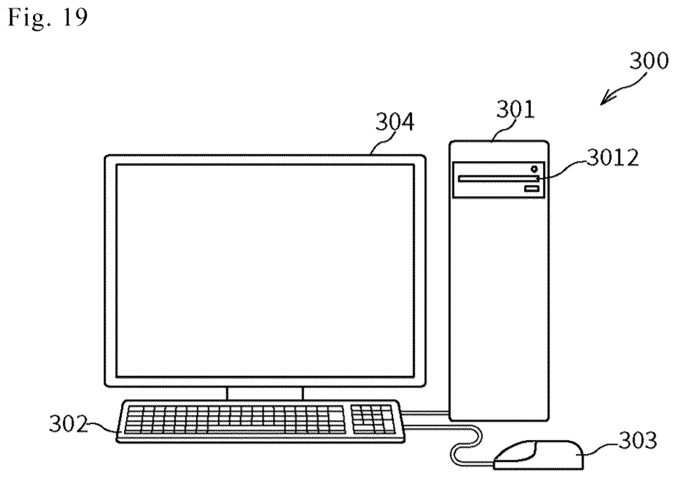

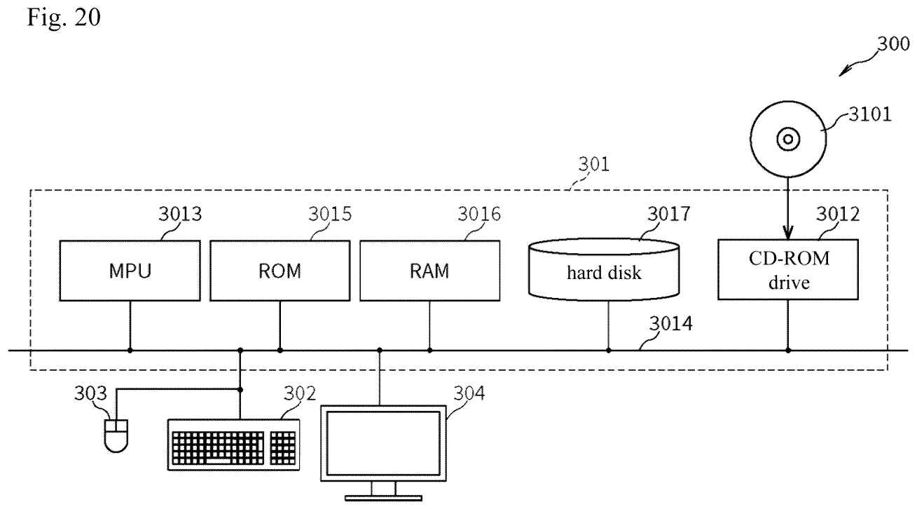

FIG. 19 shows the external appearance of a computer that executes the program described in this specification and achieves the devices such as the information processing device 1, the mobile terminal 2 and the user terminal 3 according to the various kinds of embodiments described above. The above described embodiments can be implemented with computer hardware and a computer program executed on the computer hardware. FIG. 19 is a schematic diagram of a computer system 300 and FIG. 20 is a block diagram of the system 300.

In FIG. 19, the computer system 300 includes a computer 301 including a CD-ROM drive, a keyboard 302, a mouse 303 and a monitor 304.

In FIG. 20, the computer 301 includes a CD-ROM drive 3012, a microprocessor unit (MPU) 3013, a bus 3014 connected to the CD-ROM drive 3012 or the like, a read-only memory (ROM) 3015 storing programs such as a boot-up program, a random access memory (RAM) 3016 connected to the MPU 3013, temporary storing a command from an application program, and providing a temporarily storing space, and a hard disk 3017 storing an application program, a system program and data. Although not shown in the figure, the computer 301 may further include a network card that allows connection to a local area network (LAN).

A program that causes the computer system 300 to function as, for example, the information processing device 1 according to the above described embodiment may be stored in a CD-ROM 3101, inserted into the CD-ROM drive 3012 and transferred to the hard disk 3017. Alternatively, the program may be transmitted to the computer 301 through a not-illustrated network and stored in the hard disk 3017. The program is loaded on the RAM 3016 when the program is executed. The program may be directly loaded from the CD-ROM 3101 or the network.

It is not necessary for the programs to include, for example, a third party program or an operation system (OS) that causes the computer 301 to function as, for example, the information processing device 1 according to the above described embodiment. The programs may be any program that includes a command to call an appropriate function (module) in a controlled manner and obtain an intended result. The manner in which the computer system 300 operates is conventionally known. Thus, the detailed explanation is omitted.

The steps in the above described program, such as transmitting or receiving information, do not include processing performed by hardware, or for example, processing performed by a modem or an interface card in the transmission step (processing performed by hardware alone).

One or more computers may execute the above described program. Namely, either integrated processing or distributed processing may be performed.

In each of the above described embodiments, a plurality of communicators included in a single device may be implemented by a single physical medium.

In each of the embodiments, each process may be performed by a single device through integrated processing or by multiple devices through distributed processing.

The present invention is not limited to the above embodiments, but may be modified variously within the scope of the present invention.

### INDUSTRIAL APPLICABILITY

As described above, the information processing device 1 of the present invention has the effect capable of utilizing the video captured by the mobile terminal of the performer during the performance of the performer and is effective as a server or the like for providing the video.

1. An information processing device comprising:
a receiver configured to receive an image from each of one or more mobile terminals installed on a performer;
an inquiry receiver configured to receive an inquiry from a user terminal;
an obtainer configured to obtain the image corresponding to the performer satisfying the inquiry; and
a transmitter configured to transmit the image obtained by the obtainer to the user terminal, wherein
the image obtained by the obtainer is associated with a right holder identifier for identifying a right holder of the image, and
a right holder processor is further provided to perform a right holder process which is a process related to the right holder identified by the right holder identifier associated with the image.

2. The information processing device according to claim 1, wherein
the right holder processor includes a third preserver configured to accumulate the image while being associated with the right holder identifier for identifying a user of the user terminal.

3. The information processing device according to claim 1, wherein
the receiver is configured to receive the image from a plurality of mobile terminals,
the inquiry receiver is configured to receive the inquiry including a performer condition identifying a plurality of performers,
the obtainer is configured to obtain the image corresponding to each of the plurality of performers satisfying the performer condition,
a generator is further provided to generate one image using a plurality of images obtained by the obtainer, and
the transmitter is configured to transmit the image generated by the generator to the user terminal.

4. The information processing device according to claim 3, wherein
the generator is configured to generate the one image by connecting the plurality of images in a time series manner or by merging the plurality of images in a spatial manner.

5. An information processing method implemented by a receiver, an inquiry receiver, an obtainer, a transmitter and a right holder processor, the method comprising:
a receiving step of receiving, by the receiver, an image from each of one or more mobile terminals installed on a performer;
an inquiry receiving step of receiving, by the inquiry receiver, an inquiry from a user terminal;
an obtaining step of obtaining, by the obtainer, the image corresponding to the performer satisfying the inquiry; and
a transmitting step of transmitting, by the transmitter, the image obtained by the obtainer to the user terminal, wherein
the image obtained by the obtainer is associated with a right holder identifier for identifying a right holder of the image, and
the method further comprising:
a right holder processing step of performing, by the right holder processor, a right holder process which is a process related to the right holder identified by the right holder identifier associated with the image.
